(19) United States
(12) Patent Application Publication
(10) Pub. No.: US 2026/0021614 A1
(43) Pub. Date: Jan. 22, 2026

(54) INJECTION MOLDING DEVICE, INJECTION MOLDING METHOD AND ARTICLE FORMED THEREOF

(71) Applicant: KING STEEL MACHINERY CO., LTD., TAICHUNG CITY (TW)

(72) Inventors: CHING-HAO CHEN, TAICHUNG CITY (TW); YI-CHUNG LEE, TAICHUNG CITY (TW)

(21) Appl. No.: 19/087,570

(22) Filed: Mar. 23, 2025

Related U.S. Application Data
(60) Provisional application No. 63/673,187, filed on Jul. 19, 2024.

(51) Int. Cl. B29C 45/16; B29C 44/12; B29K 75/00; B29K 105/04; B32B 5/20; B32B 27/06; B32B 27/40

(52) U.S. Cl. CPC B29C 45/1676; B29C 44/1271; B32B 5/20; B32B 27/065; B32B 27/40; B29K 2075/00; B29K 2105/04

(57) ABSTRACT

An injection molding method is provided. A molding device is provided and includes a first mold, a second mold over the first mold and a mold cavity defined by the first mold and the second mold. A first mixture is injected into the mold cavity through a first feeding port. A first component is formed from the first mixture. A second mixture is injected into the mold cavity through a second feeding port. A second component is formed from the second mixture. The second component is at least partially contact with the first component, and the first component and the second component have different physical properties.

### CROSS-REFERENCE TO RELATED APPLICATION

The present application claims priority to U.S. Provisional Patent Application No. 63/673,187, filed on Jul. 19, 2024, which is incorporated by reference herein in their entirety.

### TECHNICAL FIELD

The present disclosure discloses an injection molding device, an injection molding method and an article formed thereof, and particularly an injection molding device implementing an injection molding method to form an article including more than one portion having different physical or functional properties.

### BACKGROUND

Foamed polymeric material has many advantages, such as high strength, low weight, impact resistance, thermal insulation, and others. Foamed articles can be made by injection molding or extrusion molding. For example, after the polymeric material is melted and mixed with a blowing agent to form a mixture, a force or pressure is applied to the mixture to inject or extrude the mixture into a cavity of a mold, and the mixture is foamed and cooled in the cavity to form the foamed article.

However, it is necessary to improve the properties of the foamed article made by the injection molding system, such as causing different portions of the foamed article to have different properties. Therefore, there is a need for improvements to structures of the injection-molding system and the method for making foamed articles.

### BRIEF SUMMARY OF THE DISCLOSURE

The present disclosure discloses an injection molding device, an injection molding method and an article formed thereof.

According to one embodiment of the present disclosure, a molding method is provided. The molding method includes: providing a molding device including a first mold and a second mold, wherein the first mold includes a recess recessed into the first mold, and the second mold includes a feeding port extending through the second mold; engaging the first mold with the second mold to form a mold cavity defined by the first mold and the second mold, wherein the mold cavity is communicable with the recess and the feeding port; injecting a flowable material into the mold cavity through the feeding port to fill the recess and the mold cavity; and foaming the flowable material to a foamed article.

According to one embodiment of the present disclosure, a molding method is provided. The molding method includes: providing a molding device including a first mold and a second mold, wherein the first mold includes a cooling mechanism embedded in the first mold, and the second mold includes a feeding port extending through the second mold; engaging the first mold with the second mold to form a mold cavity defined by the first mold and the second mold; injecting a flowable material into the mold cavity through the feeding port; operating the cooling mechanism to cool down the flowable material around the cooling mechanism; and foaming the flowable material to a foamed article.

According to one embodiment of the present disclosure, a foamed article is provided. The foamed article includes a first surface, a second surface opposite to the first surface, and a third surface between the first surface and the second surface. The foamed article includes a first trace and a second trace. The first trace is disposed on the first surface. The second trace is disposed on the second surface, opposite to the first trace and vertically aligned with the first trace.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1 is a schematic of an injection molding device in an open configuration in accordance with one embodiment of the present disclosure.

FIG. 2 is a schematic of an injection molding device in a closed configuration in accordance with one embodiment of the present disclosure.

FIG. 3 is a schematic cross-sectional view illustrating engaging an injector with the feeding port in accordance with one embodiment of the present disclosure.

FIG. 4 is a schematic cross-sectional view illustrating a flowable material is injected into the mold cavity from the injector through the outlet and the feeding port in accordance with one embodiments of the present disclosure.

FIGS. 5-8 are schematic cross-sectional views illustrating exemplary stages in the injection molding method according to one embodiment of the present disclosure.

FIGS. 9-12 are schematic views illustrating the foamed article according to one embodiment of the present disclosure.

FIG. 13 is a schematic of an injection molding device in accordance with one embodiment of the present disclosure.

FIG. 14 is a schematic cross-sectional view illustrating engaging an injector with the feeding ports in accordance with one embodiment of the present disclosure.

FIG. 15 is a schematic cross-sectional view illustrating engaging multiple injectors with the feeding ports in accordance with one embodiment of the present disclosure.

FIG. 16 is a schematic cross-sectional view illustrating a flowable material is injected into the mold cavity from the injectors through the outlets and the feeding ports in accordance with one embodiments of the present disclosure.

FIGS. 17-20 are schematic cross-sectional views illustrating exemplary stages in the injection molding method according to one embodiment of the present disclosure.

FIGS. 21-24 are schematic views illustrating the foamed article according to one embodiment of the present disclosure.

FIG. 25 is a schematic of an injection molding device in accordance with one embodiment of the present disclosure.

FIG. 26 is a schematic top cross-sectional view of the injection molding device along a line CC′ in FIG. 25.

FIG. 27 is a schematic cross-sectional view illustrating engaging an injector with the feeding port in accordance with one embodiment of the present disclosure.

FIGS. 28-29 are schematic cross-sectional views illustrating exemplary stages in the injection molding method according to one embodiment of the present disclosure.

FIGS. 30-34 are schematic views illustrating the foamed article according to one embodiment of the present disclosure.

FIG. 35 is a schematic of an injection molding device in accordance with one embodiment of the present disclosure.

FIG. 36 is a schematic top cross-sectional view of the first mold along a line DD′ in FIG. 35.

FIG. 37 is a schematic top cross-sectional view of the second mold along a line EE′ in FIG. 35.

FIGS. 38-42 are schematic views illustrating the foamed article according to one embodiment of the present disclosure.

FIG. 43 is a schematic of an injection molding device in accordance with one embodiment of the present disclosure.

FIG. 44 is a schematic top cross-sectional view of the first mold along a line FF′ in FIG. 43.

FIGS. 45-48 are schematic cross-sectional views illustrating exemplary stages in the injection molding method according to one embodiment of the present disclosure.

FIGS. 49-52 are schematic views illustrating the foamed article according to one embodiment of the present disclosure.

FIGS. 53-54 are schematic views of an injection molding device in accordance with one embodiment of the present disclosure.

FIGS. 55-58 are schematic cross-sectional views illustrating exemplary stages in the injection molding method according to one embodiment of the present disclosure.

FIG. 59 is a schematic of an injection molding device in accordance with one embodiment of the present disclosure.

FIGS. 60-66 are schematic cross-sectional views illustrating exemplary stages in the injection molding method according to one embodiment of the present disclosure.

FIG. 67 is a schematic of an injection molding device in accordance with one embodiment of the present disclosure.

FIG. 68 is a schematic top cross-sectional view of the injection molding device along a line GG′ in FIG. 67.

FIG. 69 is a schematic cross-sectional view illustrating engaging an injector with the feeding port in accordance with one embodiment of the present disclosure.

FIGS. 70-71 are schematic cross-sectional views illustrating exemplary stages in the injection molding method according to one embodiment of the present disclosure.

FIGS. 72-76 are schematic views illustrating the foamed article according to one embodiment of the present disclosure.

FIG. 77 is a schematic of an injection molding device in accordance with one embodiment of the present disclosure.

FIG. 78 is a schematic top cross-sectional view of the injection molding device along a line HH′ in FIG. 77.

FIG. 79 is a schematic cross-sectional view illustrating engaging an injector with the feeding port in accordance with one embodiment of the present disclosure.

FIGS. 80-81 are schematic cross-sectional views illustrating exemplary stages in the injection molding method according to one embodiment of the present disclosure.

FIGS. 82-85 are schematic views illustrating the foamed article according to one embodiment of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the respective testing measurements. Also, as used herein, the term “about” generally means within 10%, 5%, 1%, or 0.5% of a given value or range. Alternatively, the term “about” means within an acceptable standard error of the mean when considered by one of ordinary skill in the art. Other than in the operating/working examples, or unless otherwise expressly specified, all of the numerical ranges, amounts, values and percentages, such as those for quantities of materials, durations of times, temperatures, operating conditions, ratios of amounts, and the likes thereof disclosed herein, should be understood as modified in all instances by the term “about.” Accordingly, unless indicated to the contrary, the numerical parameters set forth in the present disclosure and the attached claims are approximations that can vary as desired. At the very least, each numerical parameter should be construed in light of the number of reported significant digits and by applying ordinary rounding techniques. Ranges can be expressed herein as from one endpoint to another endpoint or between two endpoints. All ranges disclosed herein are inclusive of the endpoints, unless specified otherwise.

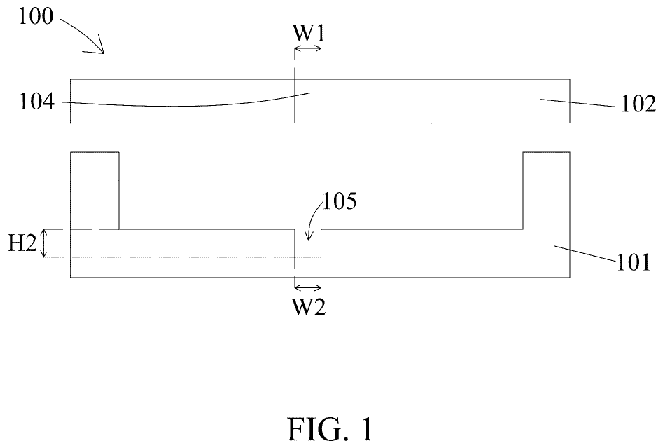

In some embodiments, a first injection molding device 100 in an open configuration is illustrated in FIG. 1. In some embodiments, the first injection molding device 100 is configured to form a foamed article. The first injection molding device 100 includes a first mold 101 and a second mold 102 engageable with the first mold 101. In some embodiments, the first mold 101 is disposed under the second mold 102. In some embodiments, the first mold 101 is a lower mold, and the second mold 102 is an upper mold. The first injection molding device 100 includes a feeding port 104 configured to allow a flowable material passing through. In some embodiments, the feeding port 104 is disposed at the first mold 101 or the second mold 102. Although FIG. 1 illustrates the feeding port 104 at the second mold 102, it would be understood that it is not limited. In some embodiments, the first injection molding device 100 includes a well 105 recessed into the first mold 101 or the second mold 102. Although FIG. 1 illustrates the well 105 is disposed at and recessed into the first mold 101, it would be understood that it is not limited. In some embodiments, the well 105 is configured to temporarily hold a material. In some embodiments, the well 105 is a cold slug, a cold well or the like. In some embodiments, a width W1 of the feeding port 104 is substantially different from or identical to a width W2 of the well 105. In some embodiments, the width W1 is substantially greater or smaller than the width W2. In some embodiments, a ratio of the width W2 to a height of the well 105 is about 1:1 to about 1:1.5. In some embodiments, the width W2 is about 5 mm to about 10 mm.

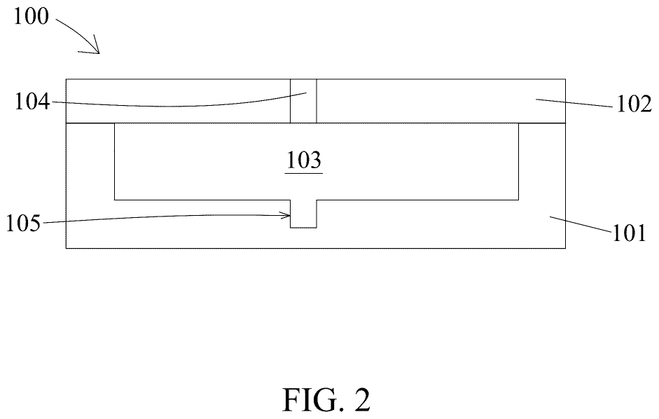

FIG. 2 illustrates the first injection molding device 100 in a closed configuration, that the first mold 101 is engaged with the second mold 102. In some embodiments, a mold cavity 103 is formed when the first injection molding device 100 is in the closed configuration. The mold cavity 103 is configured to hold a material. The feeding port 104 is communicable with the mold cavity 103. In some embodiments, the feeding port 104 is vertically aligned with the well 105 when the first injection molding device 100 is in the closed configuration.

In some embodiments, an injection molding method includes several steps as illustrated in FIGS. 1 to 12. The first injection molding device 100 is configured to implement the injection molding method.

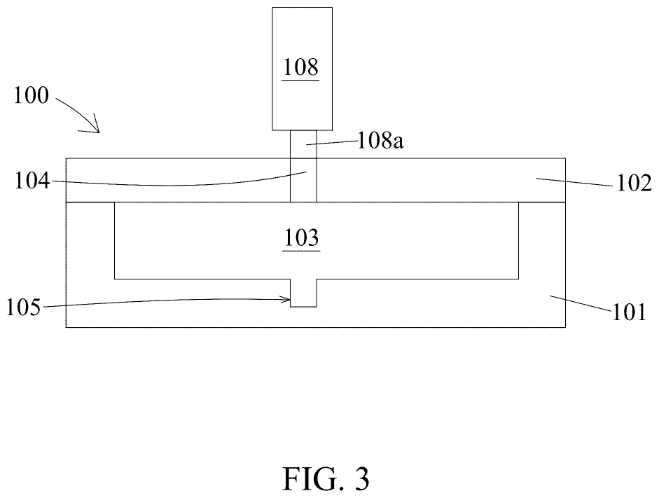

The injection molding method includes providing the first injection molding device 100 including the first mold 101 and the second mold 102 as shown in FIG. 1, and then engaging the first mold 101 with the second mold 102 as shown in FIG. 2. In some embodiments, the injection molding method includes engaging an injector 108 with the feeding port 104 as shown in FIG. 3. In some embodiments, the injector 108 is engaged with the feeding port 104 before or after the engagement of the first mold 101 and the second mold 102. In some embodiments, an outlet 108a of the injector 108 is engaged with the feeding port 104 before or after the engagement of the first mold 101 and the second mold 102. In some embodiments, the injector 108 is configured to inject a flowable material into the mold cavity 103 through the outlet 108a and the feeding port 104. In some embodiments, the injector 108 is connected to a mixing unit configured to mix a polymeric material with a blowing agent. In some embodiments, the flowable material is a mixture of a polymeric material (such as polyurethane (PU), thermoplastic polyurethane (TPU), etc.) and a blowing agent (such as physical blowing agent, for example carbon dioxide, nitrogen, supercritical fluid, etc.). The mixture is foamable or slightly foamable. The mixture can undergo a physical foaming process within the mold cavity 103. The mixture inside the mold cavity 103 becomes a foamed article after the physical foaming process.

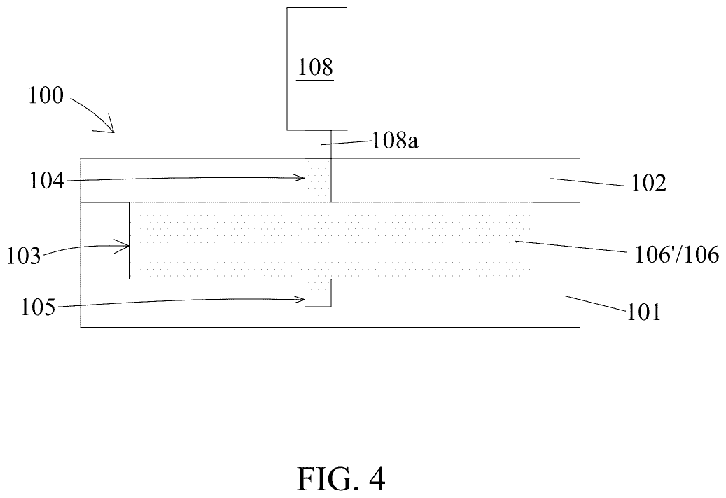

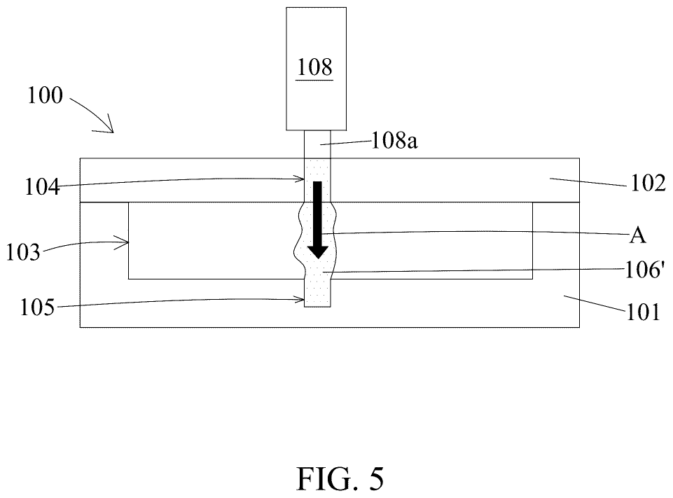

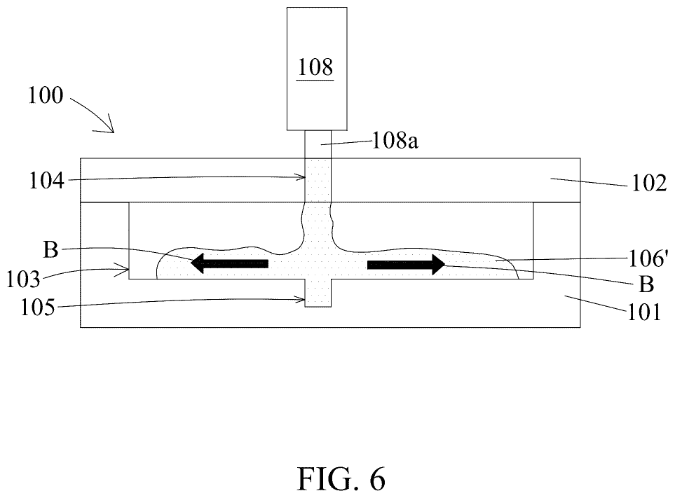

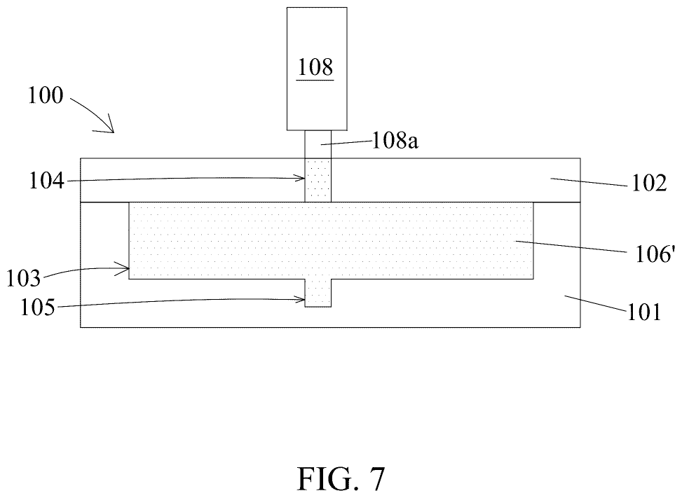

The injection molding method includes injecting a flowable material inside the first injection molding device 100. FIG. 4 illustrates a flowable material 106′ is injected into the mold cavity 103 from the injector 108 through the outlet 108a and the feeding port 104. In some embodiments, a flow of the flowable material 106′ is illustrated by FIGS. 5 to 7. In some embodiments, when the flowable material 106′ is injected from the outlet 108a of the injector 108, the flowable material 106′ flows through the feeding port 104 and the mold cavity 103 toward the well 105 as shown by an arrow A in FIG. 5. As such, some of the flowable material 106′ is disposed within the well 105. The flowable material 106′ is then continued to flow toward two sidewalls of the mold cavity 103 as shown by an arrow B in FIG. 6. In some embodiments, after filling the well 105 with the flowable material 106′, the flowable material 106′ continues to flow toward two sidewalls of the mold cavity 103. In some embodiments, the flowable material 106′ ultimately fills the mold cavity 103 as shown in FIG. 7. After the injection of the flowable material 106′, the flowable material 106′ undergoes physical foaming inside the mold cavity 103 to become a foamed article 106 as shown in FIG. 4.

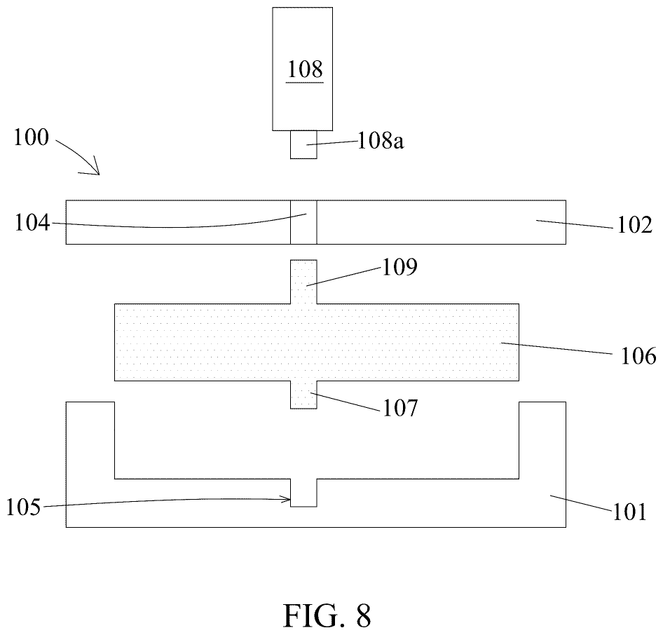

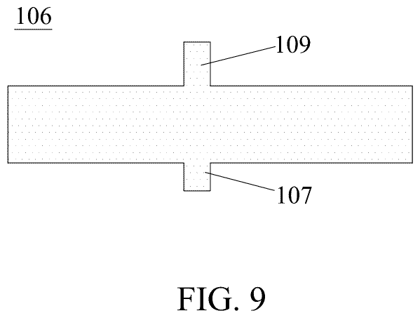

The injection molding method includes disengaging the first mold 101 from the second mold 102 to open the first injection molding device 100. FIG. 8 illustrates an opening of the first injection molding device 100 after the formation of the foamed article 106. In some embodiments, the outlet 108a of the injector 108 is disengaged with the feeding port 104 before or after the disengagement of the first mold 101 with the second mold 102. After the opening of the first injection molding device 100, the foamed article 106 is taken out from the first injection molding device 100 as shown in FIGS. 8 and 9.

The injection molding method includes forming an article by foaming process. FIG. 9 illustrates the foamed article 106 formed by the first injection molding device 100. In some embodiments, the foamed article 106 includes a first protrusion 107 and a second protrusion 109. In some embodiments, the first protrusion 107 is vertically aligned with the second protrusion 109. In some embodiments, the first protrusion 107 corresponds to and is complementary to at least a portion of the well 105, and the second protrusion 109 corresponds to and is complementary to at least a portion of the feeding port 104.

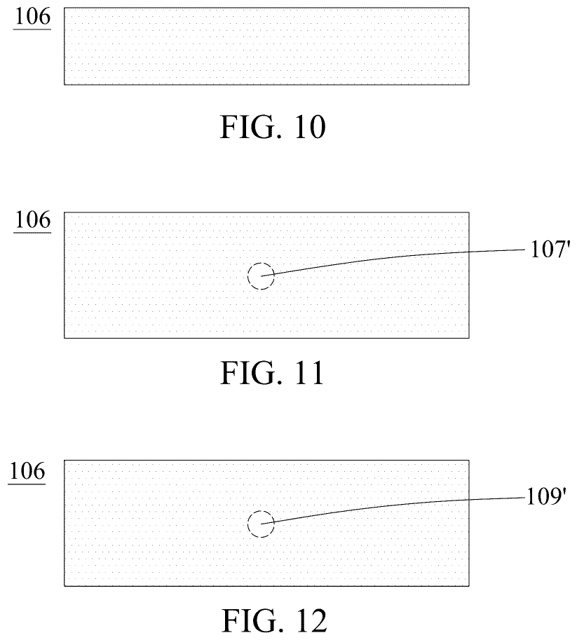

In some embodiments, the first protrusion 107 and the second protrusion 109 are removed as shown in FIGS. 10 to 12. FIG. 10 is a schematic side view of the foamed article 106, FIG. 11 is a schematic bottom view of the foamed article 106, and FIG. 12 is a schematic top view of the foamed article 106. In some embodiments, the first protrusion 107 and the second protrusion 109 are removed by cutting, trimming, grinding or any other suitable process. As a result, a first trimming trace 107′ is formed on a bottom surface of the foamed article 106, and a second trimming trace 109′ is formed on a top surface of the foamed article 106. In some embodiments, the first trimming trace 107′ and the second trimming trace 109′ do not include a skin layer because a skin layer is damaged or removed by the trimming process. In some embodiments, the foamed article 106 is a component of a footwear article, such as an outsole or the like.

Referring back to FIG. 5, since the flowable material 106′ flows into and fills the well 105 first and then fills the mold cavity 103, a flow trace surrounding the first protrusion 109 and disposed on the top surface of the foamed article 106 is absent or minimized. Further, the flowable material 106′ inside the first injection molding device 100 has undergone a uniform foaming, and as a result pores inside the foamed article 106 are more evenly distributed and an overall density of the foamed article 106 is also more uniform.

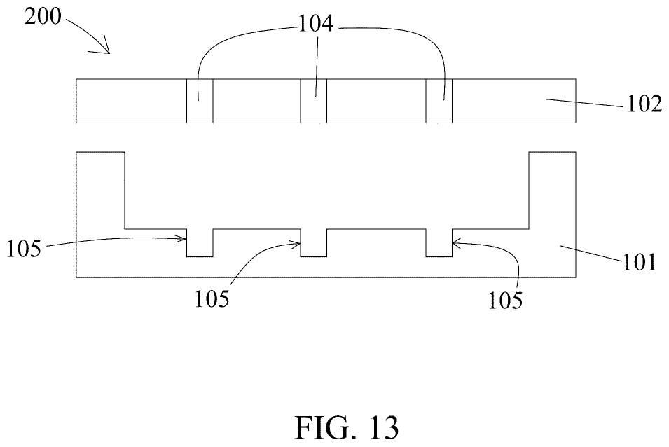

Alternatively, a second injection molding device 200 is used as shown in FIGS. 13 to 24. In some embodiments, the second injection molding device 200 is similar to the first injection molding device 100, except the quantities of the wells 105 and the feeding ports 104. As illustrated in FIG. 13, in some embodiments, the second injection molding device 200 includes several wells 105 and several feeding ports 104 corresponding to the wells 105. In some embodiments, each well 105 corresponds to one feeding port 104. In some embodiments, each well 105 is vertically aligned with the corresponding one of the feeding ports 104.

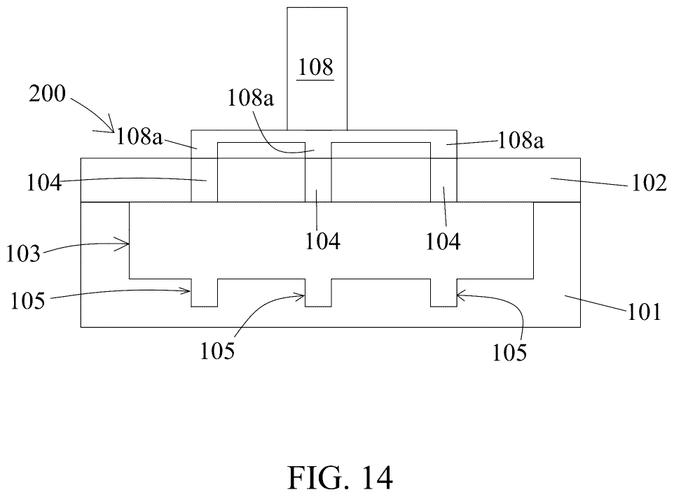

FIG. 14 illustrates the injector 108 is engaged with the second injection molding device 200. In some embodiments, the injector 108 is engaged with the feeding ports 104 before or after the engagement of the first mold 101 and the second mold 102. In some embodiments, the injector 108 includes several outlets 108a engageable with one of the feeding ports 104. Alternatively, several injectors 108 are engaged with the second injection molding device 200 as shown in FIG. 15. In some embodiments, each injector 108 has the outlet 108a, and the outlet 108a is engageable with the feeding port 104.

For simplicity and clarity, injectors 108 engaging the second injection molding device 200 is illustrated in subsequent figures for describing subsequent steps. However, it would be understood that the injector 108 of FIG. 14 can also implement the subsequent steps in similar way.

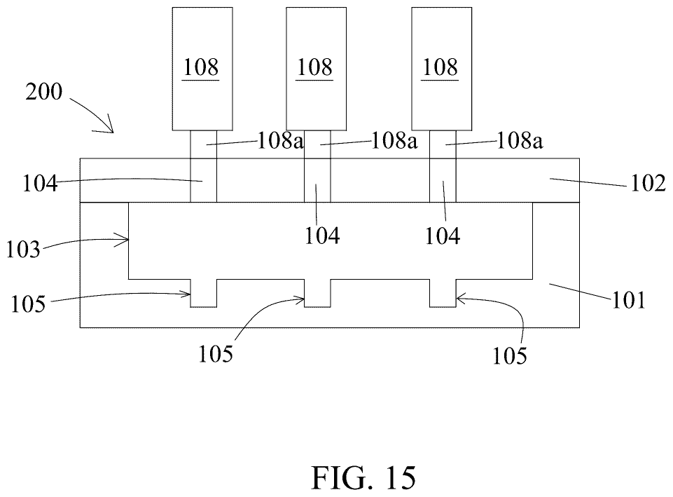

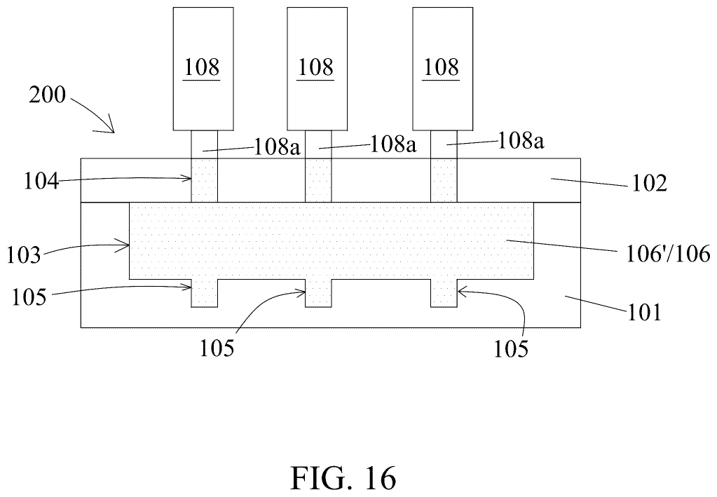

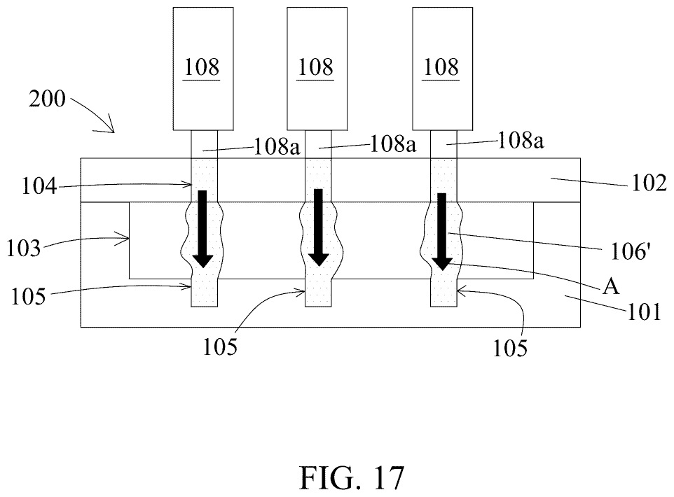

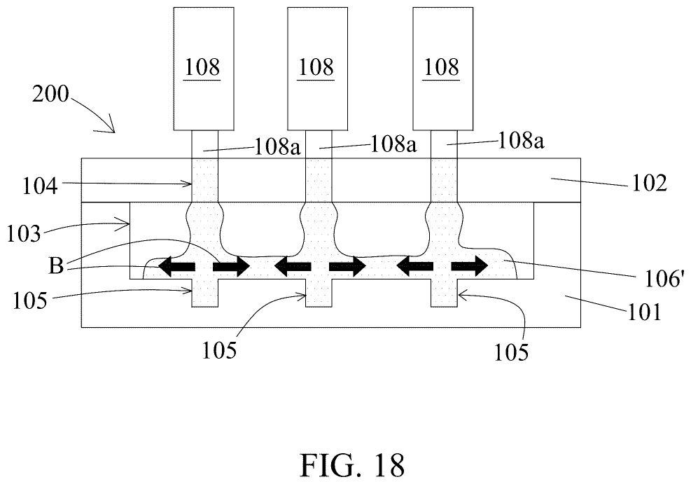

After the engagement of the injector 108 with the second injection molding device 200, the flowable material 106′ is injected into the mold cavity 103 from the injector 108 through the outlet 108a and the feeding port 104 as shown in FIG. 16. In some embodiments, a flow of the flowable material 106′ is illustrated by FIGS. 17 to 19. In some embodiments, when the flowable material 106′ is injected from the outlet 108a of the injector 108, the flowable material 106′ flows through the feeding port 104 and the mold cavity 103 toward the well 105 as shown by an arrow A in FIG. 17, similar to a way described above or illustrated in FIG. 5. As such, some of the flowable material 106′ is disposed within the well 105. The flowable material 106′ is then continued to flow toward two sidewalls of the mold cavity 103 as shown by an arrow B in FIG. 18, similar to a way described above or illustrated in FIG. 6. In some embodiments, the flowable material 106′ ultimately fills the mold cavity 103 as shown in FIG. 19. After the injection of the flowable material 106′, the flowable material 106′ undergoes physical foaming inside the mold cavity 103 to become a foamed article 106 as shown in FIG. 16.

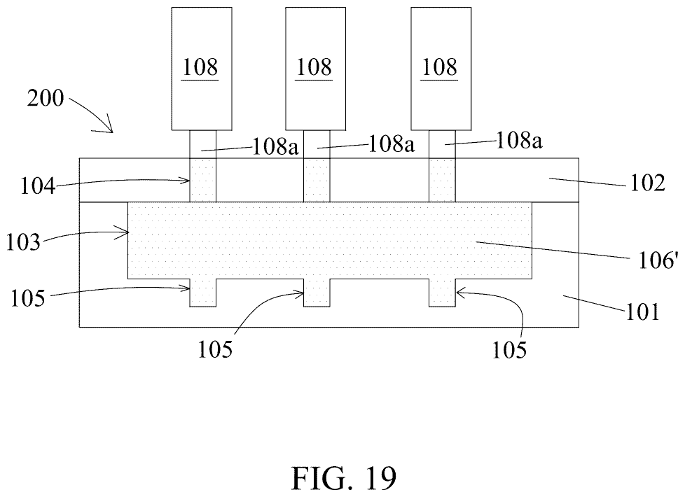

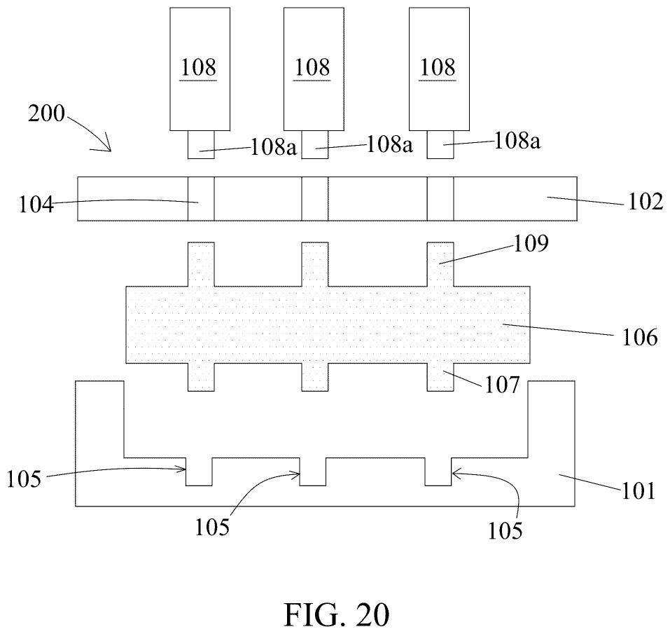

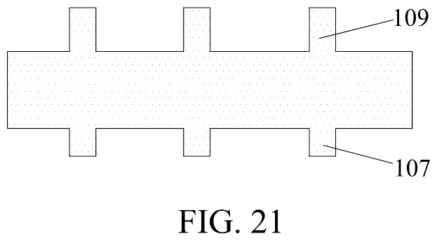

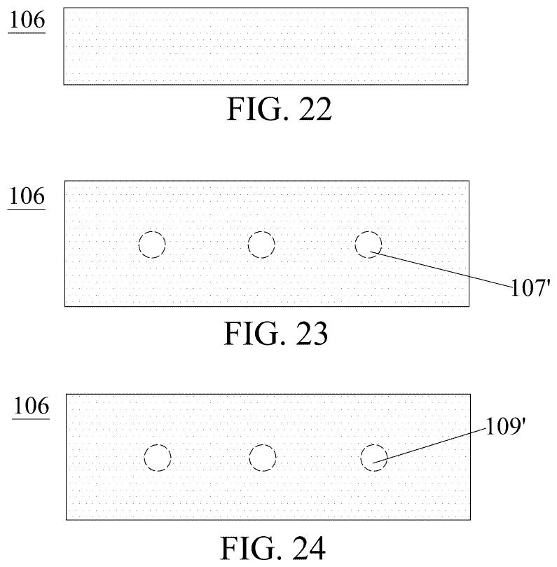

After the formation of the foamed article 106, the second injection molding device 200 is open to take out the foamed article 106 as shown in FIG. 20, similar to a way described above or illustrated in FIG. 8. FIG. 21 illustrated the foamed article 106 formed by the second injection molding device 200, similar to the foamed article 106 described above or illustrated in FIG. 9. In some embodiments, the first protrusions 107 and the second protrusions 109 are removed as shown in FIGS. 22 to 24, similar to a way described above or illustrated in FIGS. 10 to 12. FIG. 22 is a schematic side view of the foamed article 106, FIG. 23 is a schematic bottom view of the foamed article 106, and FIG. 24 is a schematic top view of the foamed article 106.

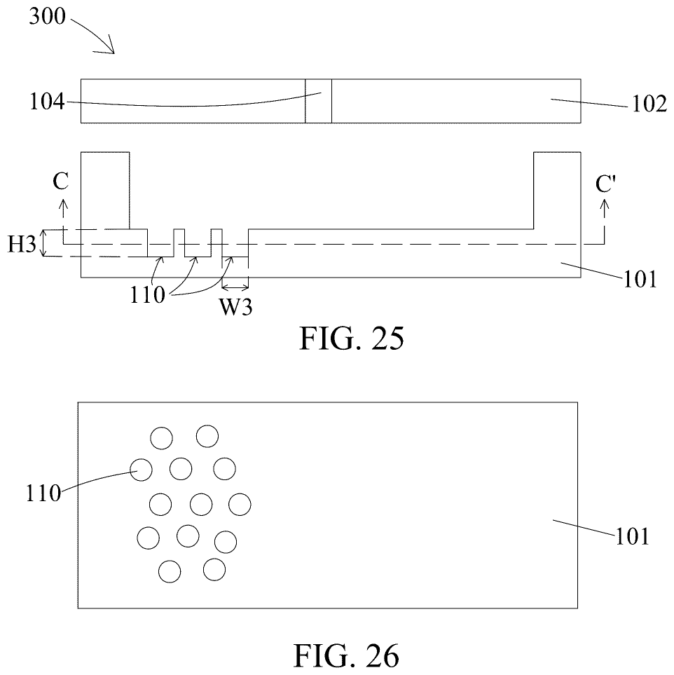

In some embodiments, a third injection molding device 300 is used for implementing another injection molding method having several steps as illustrated in FIGS. 25 to 34. FIG. 25 illustrates the third injection molding device 300 in an open configuration. In some embodiments, the third injection molding device 300 includes the first mold 101, the second mold 102 and the feeding port 104, which are similar to those in the first or second injection molding devices 100 or 200. FIG. 25 shows one feeding port 104 only, but it would be understood that more than one feeding port 104 can be included. In some embodiments, the third injection molding device 300 includes several recesses 110 indented into the first mold 101 or the second mold 102. Although FIG. 25 illustrates the recesses 110 are disposed at and recessed into the first mold 101, it would be understood that it is not limited. In some embodiments, the recess 110 is configured to temporarily hold a material. FIG. 26 is a schematic top cross-sectional view of the third injection molding device 300 along a line CC′ in FIG. 25. In some embodiments, the recesses 110 are positioned in a predetermined pattern or are randomly positioned. In some embodiments, the recesses 110 are positioned adjacent to one side (e.g. left side, right side, front portion, rear portion, etc.) of the third injection molding device 300.

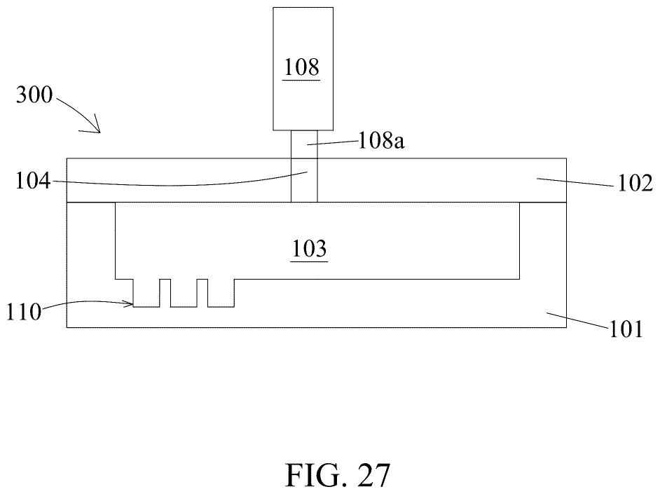

FIG. 27 illustrates the third injection molding device 300 in a closed configuration, that the first mold 101 is engaged with the second mold 102. In some embodiments, a mold cavity 103 is formed when the third injection molding device 300 is in the closed configuration. In some embodiments, the injector 108 is engaged with the third injection molding device 300 before or after the closing of the third injection molding device 300. In some embodiments, the outlet 108a of the injector is engaged with the feeding port 104, such that the flowable material can flow from the injector 108 into the mold cavity 103 through the outlet 108a and the feeding port 104.

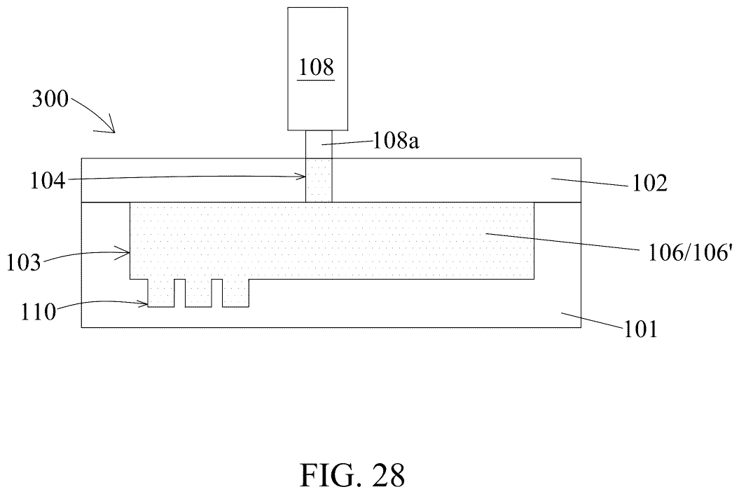

After the engagement of the injector 108, the flowable material 106′ flows into the mold cavity 103 as shown in FIG. 28. In some embodiments, the flowable material 106′ fills the recesses 110. In some embodiments, the flowable material 106′ is a mixture of a polymeric material (such as polyurethane (PU), thermoplastic polyurethane (TPU), etc.) and a blowing agent (such as physical blowing agent, for example carbon dioxide, nitrogen, supercritical fluid, etc.). The mixture is foamable or slightly foamable. The mixture can undergo a physical foaming process within the mold cavity 103. The mixture inside the mold cavity 103 becomes a foamed article after the physical foaming process.

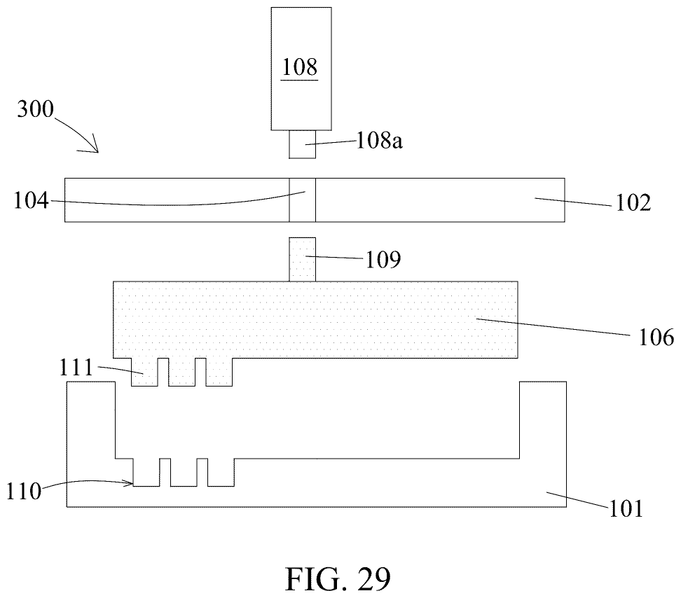

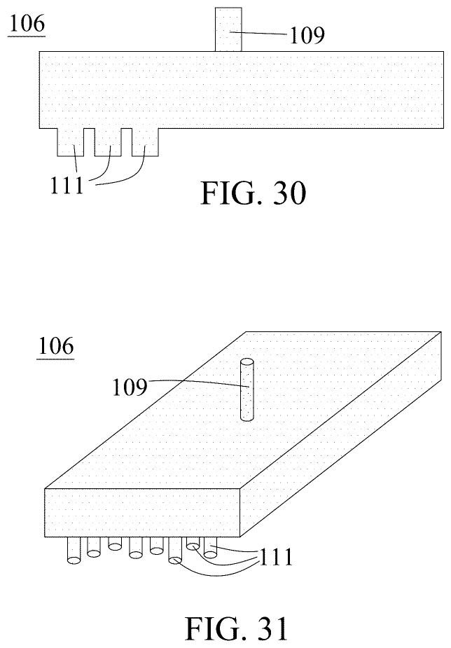

FIG. 29 illustrates an opening of the third injection molding device 300 after the formation of the foamed article 106. In some embodiments, the outlet 108a of the injector 108 is disengaged with the feeding port 104 before or after the disengagement of the first mold 101 with the second mold 102. After the opening of the first injection molding device 100, the foamed article 106 is taken out from the third injection molding device 300 as shown in FIGS. 29 and 30.

FIGS. 30 and 31 illustrate the foamed article 106 formed by the third injection molding device 300. FIG. 30 is a schematic side view of the foamed article 106, and FIG. 31 is a schematic perspective view of the foamed article 106. In some embodiments, the foamed article 106 includes a second protrusion 109 and a third protrusion 111. In some embodiments, the second protrusion 109 corresponds to and is complementary to at least a portion of the feeding port 104, and the third protrusion 111 corresponds to and is complementary to at least a portion of the recess 110.

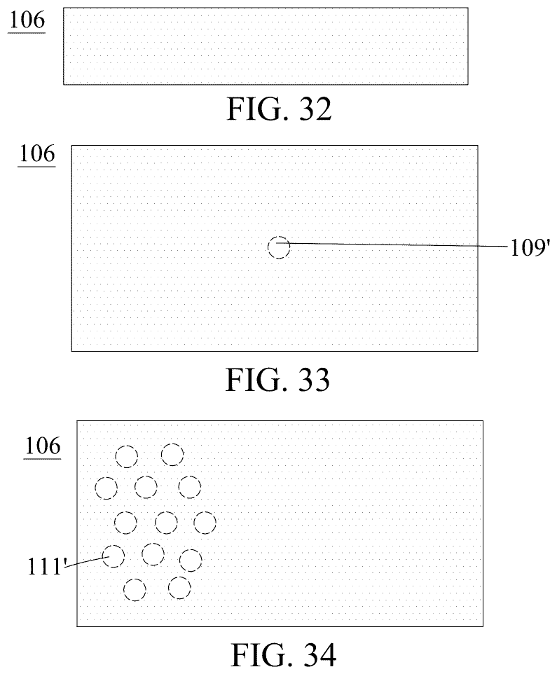

In some embodiments, the second protrusion 109 and the third protrusion 111 are removed as shown in FIGS. 32 to 34. FIG. 32 is a schematic side view of the foamed article 106, FIG. 33 is a schematic top view of the foamed article 106, and FIG. 34 is a schematic bottom view of the foamed article 106. In some embodiments, the second protrusion 109 and the third protrusion 111 are removed by cutting, trimming, grinding or any other suitable process. As a result, a second trimming trace 109′ is formed on a top surface of the foamed article 106, and a third trimming trace 111′ is formed on a bottom surface of the foamed article 106. In some embodiments, the second trimming trace 109′ and the third trimming trace 111′ do not include a skin layer because a skin layer is damaged or removed by the trimming process. In some embodiments, the foamed article 106 is a component of a footwear article, such as an outsole or the like. Since the flowable material 106′ flows into and fills the recesses 110 first and then fills the mold cavity 103, a flow trace on surfaces of the foamed article 106 is absent or minimized. Further, the flowable material 106′ inside the third injection molding device 300 has undergone a uniform foaming, and as a result pores inside the foamed article 106 are more evenly distributed and an overall density of the foamed article 106 is also more uniform.

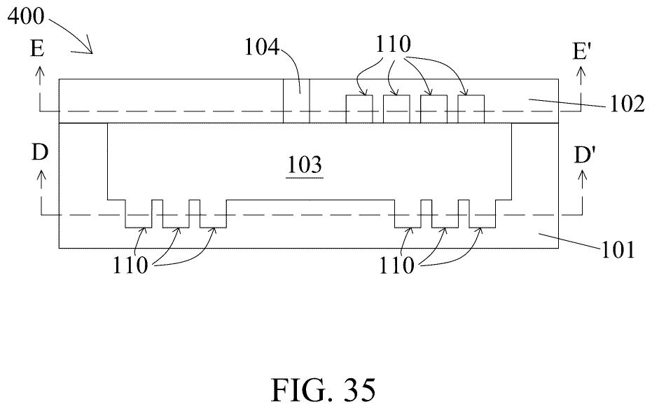

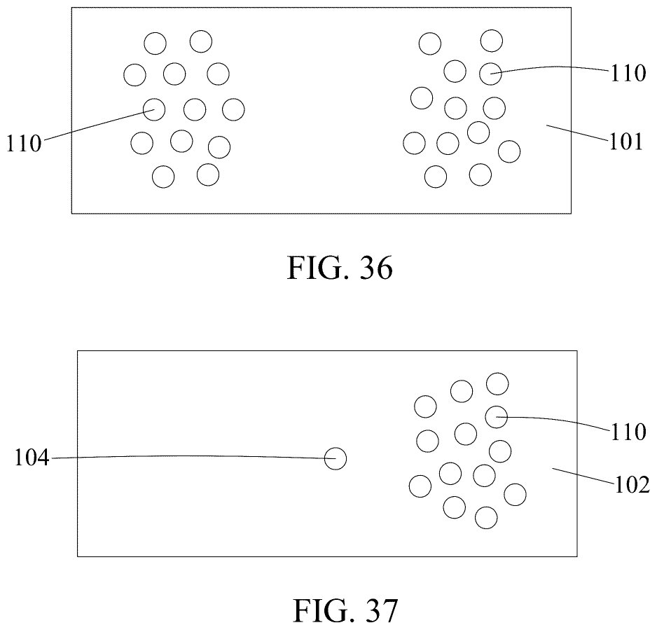

Alternatively, a fourth injection molding device 400 is used as shown in FIGS. 35 to 42. In some embodiments, the fourth injection molding device 400 is similar to the third injection molding device 300, except the recesses 110 are also disposed at the second mold 102. FIG. 35 is a schematic side view of the fourth injection molding device 400, FIG. 36 is a schematic top cross-sectional view of the first mold 101 along a line DD′ in FIG. 35, and FIG. 37 is a schematic top cross-sectional view of the second mold 102 along a line EE′ in FIG. 35.

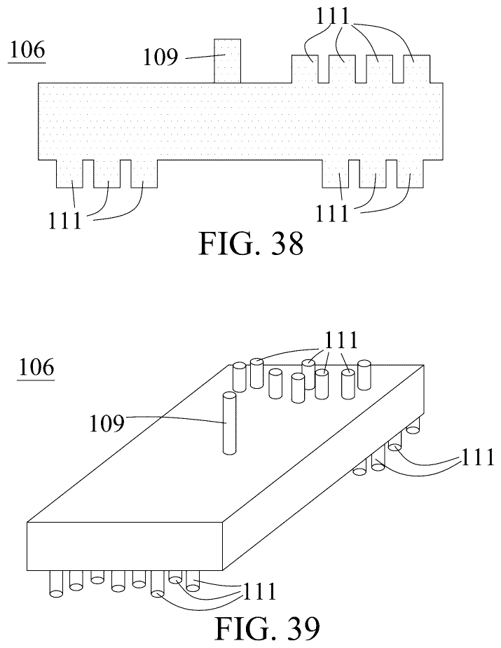

After the flowable material 106′ is flowed into the mold cavity 103 of the fourth injection molding device 400, the flowable material 106′ undergoes physical foaming to become the foamed article 106 as shown in FIGS. 38 and 39. FIG. 38 is a schematic side view of the foamed article 106, and FIG. 39 is a schematic perspective view of the foamed article 106. In some embodiments, the foamed article 106 includes a second protrusion 109 and third protrusions 111. In some embodiments, the second protrusion 109 and some of the third protrusions 111 are on a top surface of the foamed article 106. In some embodiments, some of the third protrusions 111 are on a bottom surface of the foamed article 106.

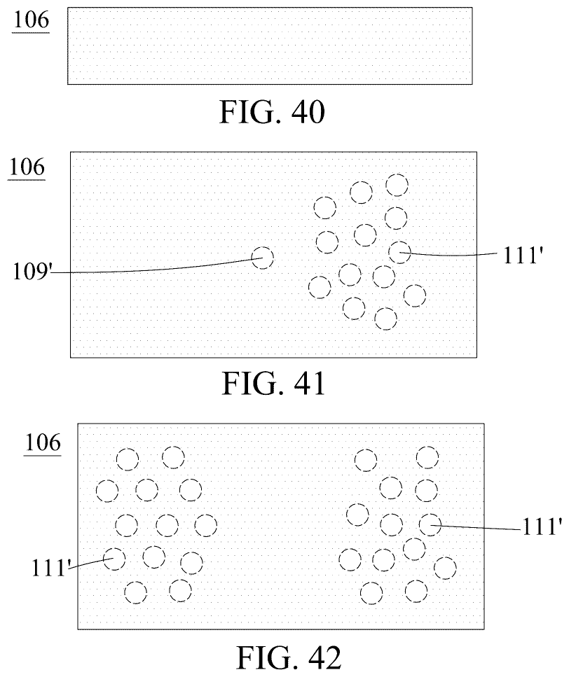

In some embodiments, the second protrusion 109 and the third protrusions 111 are removed as shown in FIGS. 40 to 42. FIG. 40 is a schematic side view of the foamed article 106, FIG. 41 is a schematic top view of the foamed article 106, and FIG. 42 is a schematic bottom view of the foamed article 106. In some embodiments, the second protrusion 109 and the third protrusions 111 are removed by cutting, trimming, grinding or any other suitable process. As a result, a second trimming trace 109′ is formed on the top surface of the foamed article 106, and third trimming traces 111′ are formed on the bottom surface of the foamed article 106.

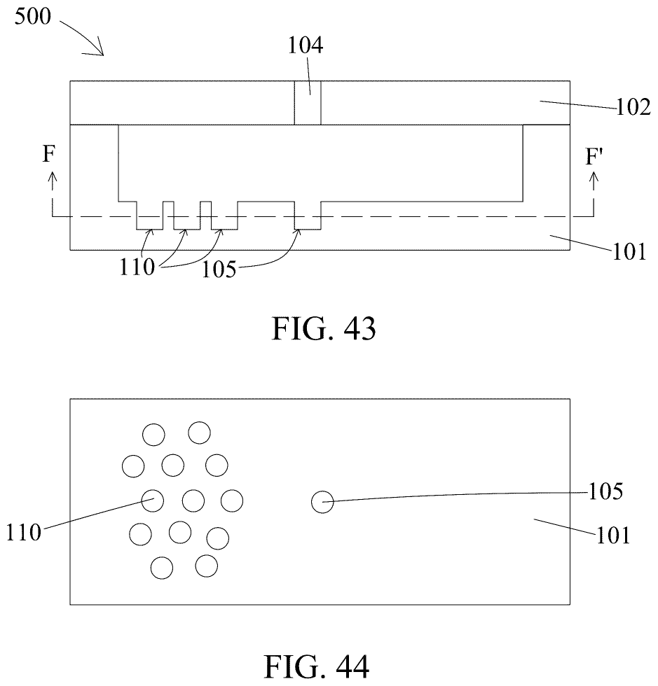

In some embodiments, a fifth injection molding device 500 is used for implementing another injection molding method having several steps as illustrated in FIGS. 43 to 52. In some embodiments, the fifth injection molding device 500 is similar to the third injection molding device 300 and the first injection molding device 100, that the fifth injection molding device 500 is a hybrid of the third injection molding device 300 and the first injection molding device 100. FIG. 43 is a schematic side view of the fifth injection molding device 500, and FIG. 44 is a schematic top cross-sectional view of the first mold 101 along a line FF′ in FIG. 43. In some embodiments, the first mold 101 includes a well 105 and several recesses 110, and the second mold 102 includes a feeding port 104 vertically aligned with the well 105.

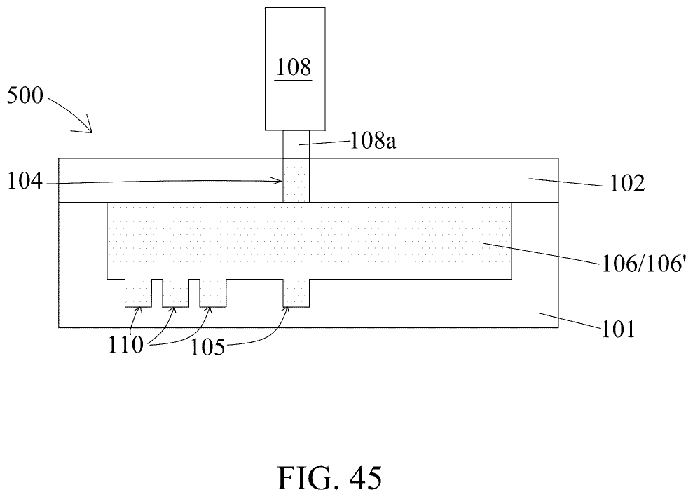

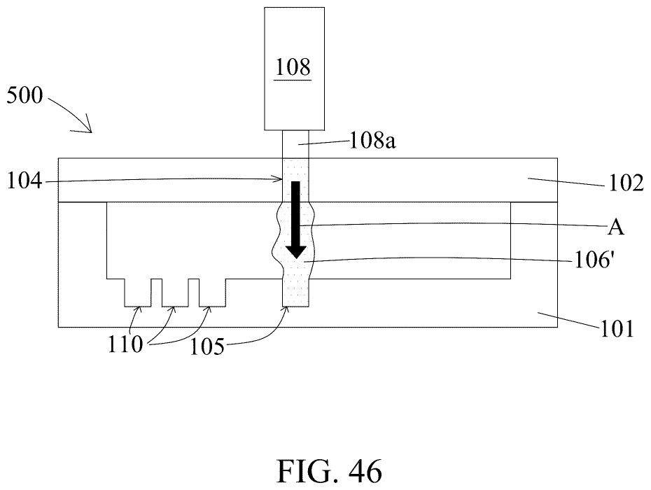

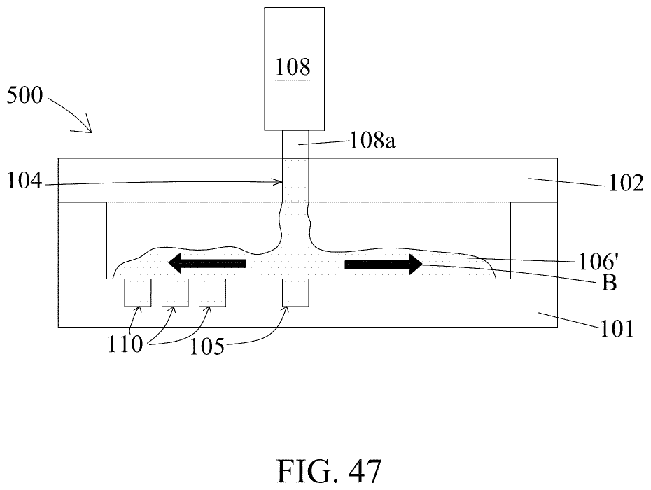

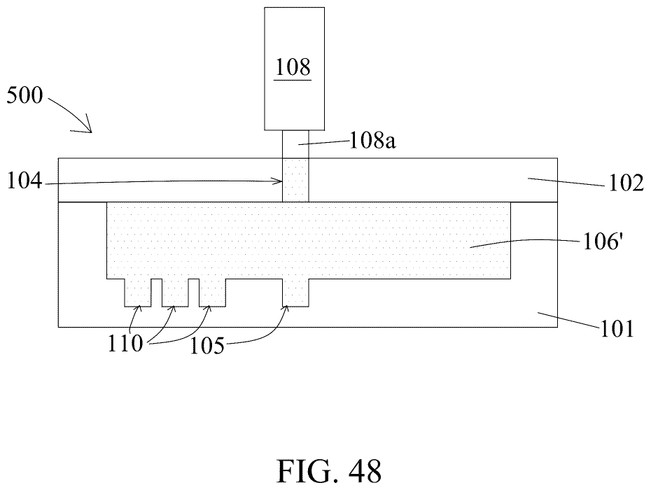

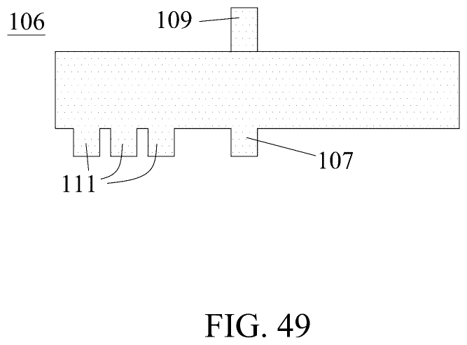

In some embodiments, after the closing of the fifth injection molding device 500 as shown in FIG. 43 and engaging the injector 108 with the fifth injection molding device 500, a flowable material 106′ is flowed from the injector 108 into the mold cavity 103 as shown in FIG. 45. In some embodiments, a flow of the flowable material 106′ is illustrated by FIGS. 46 to 48. In some embodiments, when the flowable material 106′ is injected from the outlet 108a of the injector 108, the flowable material 106′ flows through the feeding port 104 and the mold cavity 103 toward the well 105 as shown by an arrow A in FIG. 46, similar to a way described above or illustrated in FIG. 5. As such, some of the flowable material 106′ is disposed within the well 105. The flowable material 106′ is then continued to flow toward two sidewalls of the mold cavity 103 as shown by an arrow B in FIG. 47, similar to a way described above or illustrated in FIG. 6. In some embodiments, the flowable material 106′ ultimately fills the mold cavity 103 as shown in FIG. 48. After the injection of the flowable material 106′, the flowable material 106′ undergoes physical foaming inside the mold cavity 103 to become a foamed article 106 as shown in FIGS. 45 and 49. FIG. 49 is a schematic side view of the foamed article 106. In some embodiments, the foamed article 106 includes a first protrusion 107, a second protrusion 109 and third protrusions 111. In some embodiments, the first protrusion 107 and the third protrusions 111 are disposed on a bottom surface of the foamed article 106, and the second protrusion 109 is on a top surface of the foamed article 106.

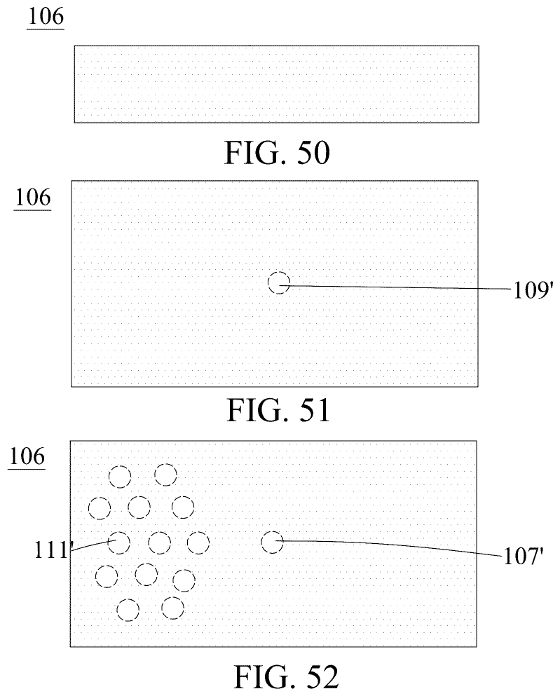

In some embodiments, the first protrusion 107, the second protrusion 109 and the third protrusions 111 are removed as shown in FIGS. 50 to 52. FIG. 50 is a schematic side view of the foamed article 106, FIG. 51 is a schematic top view of the foamed article 106, and FIG. 52 is a schematic bottom view of the foamed article 106. In some embodiments, the first protrusion 107, the second protrusion 109 and the third protrusions 111 are removed by cutting, trimming, grinding or any other suitable process. As a result, a second trimming trace is formed on the top surface of the foamed article 106, and the first trimming trace 107′ and third trimming traces 111′ are formed on the bottom surface of the foamed article 106.

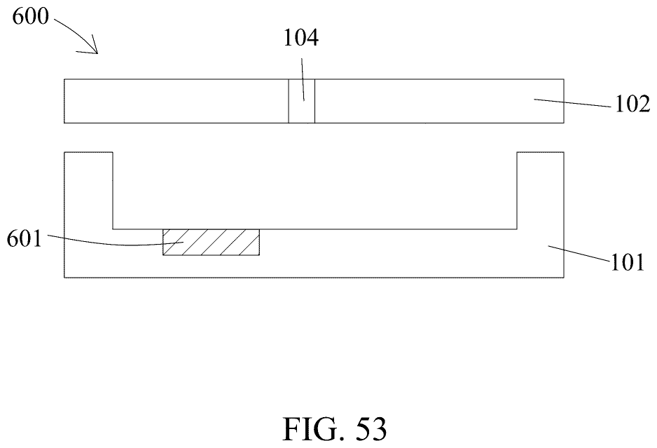

In some embodiments, a sixth injection molding device 600 is used for implementing another injection molding method having several steps as illustrated in FIGS. 53 to 58. FIG. 53 illustrates the sixth injection molding device 600 in an open configuration. The sixth injection molding device 600 includes a first mold 101 and a second mold 102 engageable with the first mold 101. The sixth injection molding device 600 includes a feeding port 104 configured to allow a flowable material passing through. In some embodiments, the feeding port 104 is disposed at the first mold 101 or the second mold 102. In some embodiments, the sixth injection molding device 600 includes a cooling mechanism 601 disposed at the first mold 101 or the second mold 102. Although FIG. 53 illustrates the cooling mechanism 601 disposed at first mold 101, it would be understood that it is not limited. Further, although only one cooling mechanism 601 is disposed in the sixth injection molding device 600, it would be understood that the quantity of the cooling mechanism 601 is not limited.

In some embodiments, the cooling mechanism 601 is configured to provide a cooling of a portion of a flowable material when the flowable material is disposed on or over the first mold 101. In some embodiments, the cooling mechanism 601 allows a liquid (such as coolant, water, etc.) flowing through or circulate to cool down a portion of the first mold 101 or a portion of the flowable material disposed on or over the first mold 101. In some embodiments, the cooling mechanism 601 is an electric cooler, a cooling device or the like.

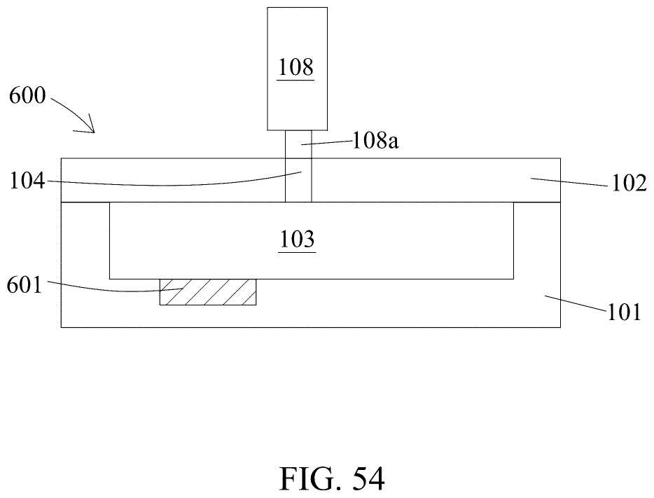

FIG. 54 illustrates the sixth injection molding device 600 in a closed configuration, that the first mold 101 is engaged with the second mold 102. In some embodiments, a mold cavity 103 is formed when the sixth injection molding device 600 is in the closed configuration. The mold cavity 103 is configured to hold a material. The feeding port 104 is communicable with the mold cavity 103. In some embodiments, an injector 108 is engaged with the feeding port 104 before or after the engagement of the first mold 101 and the second mold 102. In some embodiments, an outlet 108a of the injector 108 is engaged with the feeding port 104 before or after the engagement of the first mold 101 and the second mold 102. In some embodiments, the injector 108 is configured to inject a flowable material into the mold cavity 103 through the outlet 108a and the feeding port 104. In some embodiments, the flowable material is a mixture of a polymeric material (such as polyurethane (PU), thermoplastic polyurethane (TPU), etc.) and a blowing agent (such as physical blowing agent, for example carbon dioxide, nitrogen, supercritical fluid, etc.). The mixture is foamable or slightly foamable. The mixture can undergo a physical foaming process within the mold cavity 103. The mixture inside the mold cavity 103 becomes a foamed article after the physical foaming process.

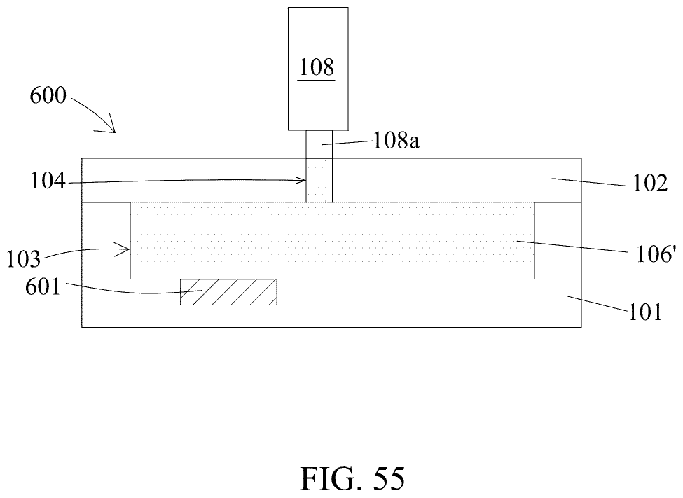

FIG. 55 illustrates a flowable material 106′ is injected into the mold cavity 103 from the injector 108 through the outlet 108a and the feeding port 104. In some embodiments, before or upon the injection of the flowable material 106′ into the mold cavity 103, a temperature of the sixth injection molding device 600 is increased before the injection of the flowable material 106′, and maintained at a first predetermined temperature during the injection of the flowable material 106′ in order to facilitate the flow of the flowable material 106′ into the mold cavity 103. In some embodiments, the first predetermined temperature is about 30° C. to about 40° C. In some embodiments, after the injection of the flowable material 106′, the flowable material 106′ inside the mold cavity 103 is at a temperature substantially equal to the first predetermined temperature.

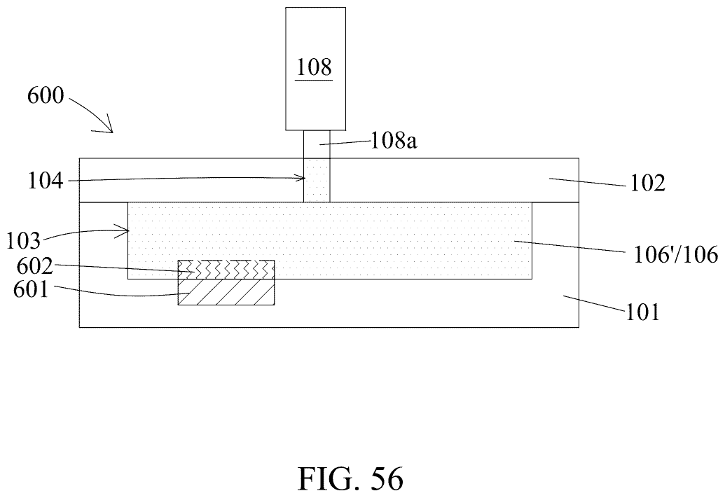

After the injection of the flowable material 106′, the flowable material 106′ undergoes physical foaming inside the mold cavity 103 to become a foamed article 106 as shown in FIG. 56. In some embodiments, after the injection of the flowable material 106′ and during the foaming of the flowable material 106′ inside the mold cavity 103, the cooling mechanism 601 is operated to cool down the flowable material 106′ around the cooling mechanism 601. In some embodiments, the cooling mechanism 601 is operated to cool down the flowable material 106′ from the first predetermined temperature to a second predetermined temperature. In some embodiments, the second predetermined temperature is substantially less than 25° C. In some embodiments, the second predetermined temperature is about 20° C. In some embodiments, a duration for cooling the flowable material 106′ around the cooling mechanism 601 from the first predetermined temperature to the second predetermined temperature by the cooling mechanism 601 is substantially less than 2 seconds.

After the cooling of the flowable material 106′ by the cooling mechanism 601 and after the foaming of the flowable material 106′, a foamed article 106 having a skin layer 602 is formed. The skin layer 602 is formed from the flowable material 106′ around the cooling mechanism 601. In some embodiments, the skin layer 602 has a thickness of about 0.5 mm to about 5 mm. In some embodiments, a density gradient is present within the skin layer 602, that a density of the skin layer 602 is gradually increased from an interior of the foamed article 106 to an exterior of the foamed article 106. In some embodiments, the skin layer 602 has lesser degree of physical foaming than the rest portion of the foamed article 106. That is, the rest portion of the foamed article 106 has higher degree of physical foaming than the skin layer 602. In some embodiments, a density of the skin layer 602 is different from a density of the rest portion of the foamed article 106. In some embodiments, the density of the skin layer 602 is substantially greater than the density of the rest portion of the foamed article 106. In some embodiments, the density of the skin layer 602 is substantially equal to or more than 0.2 g/cm³, and the density of the rest portion of the foamed article 106 is substantially less than 0.2 g/cm³.

In some embodiments, the density of the skin layer 602 is substantially equal to or more than 0.22 g/cm³, and the density of the rest portion of the foamed article 106 is substantially equal to or less than 0.16 g/cm³. In some embodiments, the skin layer 602 has higher abrasion resistance than the rest portion of the foamed article 106, because the density of the skin layer 602 is higher than the density of the rest portion of the foamed article 106.

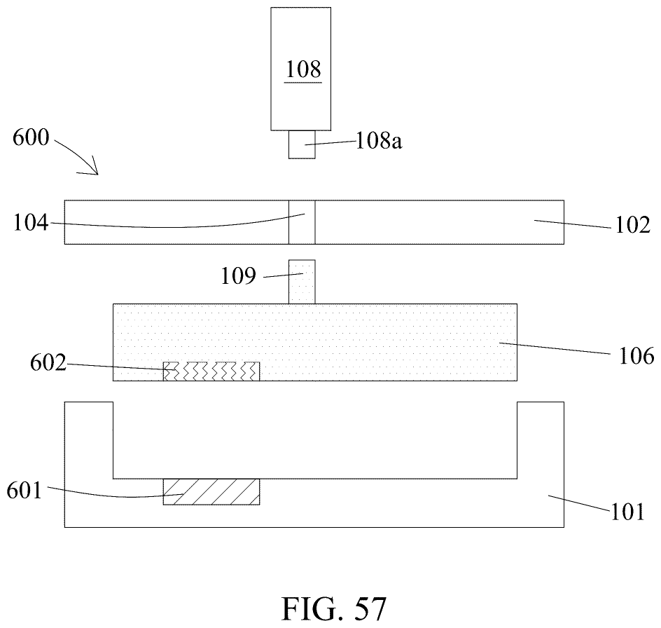

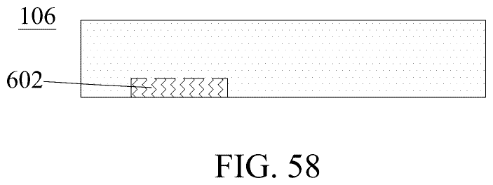

FIG. 57 illustrates an opening of the sixth injection molding device 600 after the formation of the foamed article 106 having the skin layer 602. In some embodiments, the outlet 108a of the injector 108 is disengaged with the feeding port 104 before or after the disengagement of the first mold 101 with the second mold 102. After the opening of the sixth injection molding device 600, the foamed article 106 having the skin layer 602 is taken out from the sixth injection molding device 600 as shown in FIG. 57. In some embodiments, the second protrusion 109 is removed by cutting, trimming, grinding or any other suitable process, as shown in FIG. 58.

In some embodiments, the foamed article 106 is a component of a footwear article, such as an outsole or the like. In some embodiments, the skin layer 602 is exposed to the surroundings, that no adhesive or no other component covers the skin layer 602.

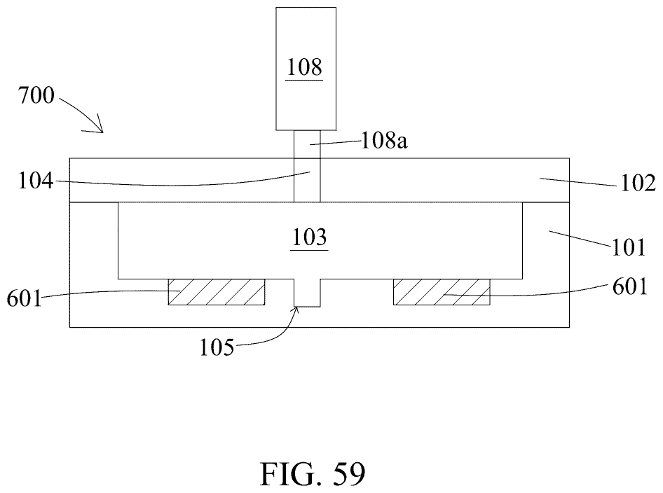

In some embodiments, a seventh injection molding device 700 is used for implementing another injection molding method having several steps as illustrated in FIGS. 59 to 66. In some embodiments, the seventh injection molding device 700 is similar to first injection molding device 100 and the sixth injection molding device 600, that the seventh injection molding device 700 is a hybrid of the first injection molding device 100 and the sixth injection molding device 600. FIG. 59 is a schematic side view of the seventh injection molding device 700 in a closed configuration. In some embodiments, the first mold 101 includes a well 105 and a cooling mechanism 601, and the second mold 102 includes a feeding port 104 vertically aligned with the well 105.

In some embodiments, before or upon the injection of the flowable material 106′ into the mold cavity 103, a temperature of the seventh injection molding device 700 is increased before the injection of the flowable material 106′, and maintained at a first predetermined temperature during the injection of the flowable material 106′ in order to facilitate the flow of the flowable material 106′ into the mold cavity 103. In some embodiments, the first predetermined temperature is about 30° C. to about 40° C. In some embodiments, after the injection of the flowable material 106′, the flowable material 106′ inside the mold cavity 103 is at a temperature substantially equal to the first predetermined temperature.

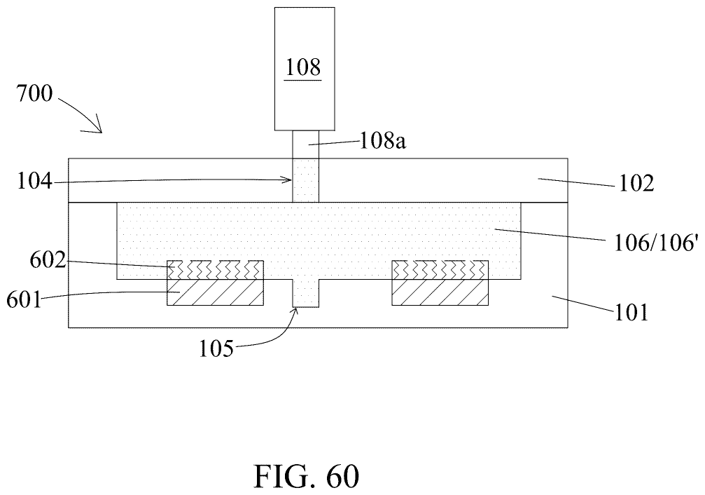

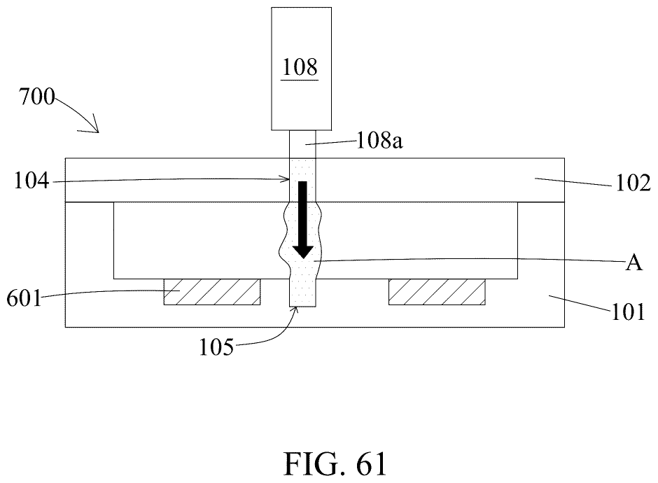

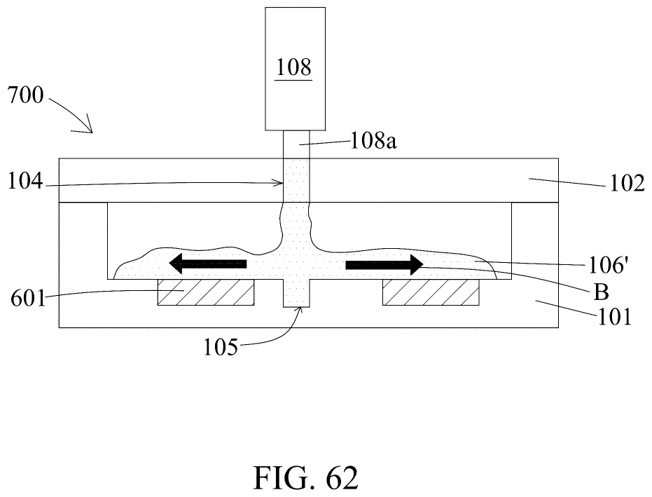

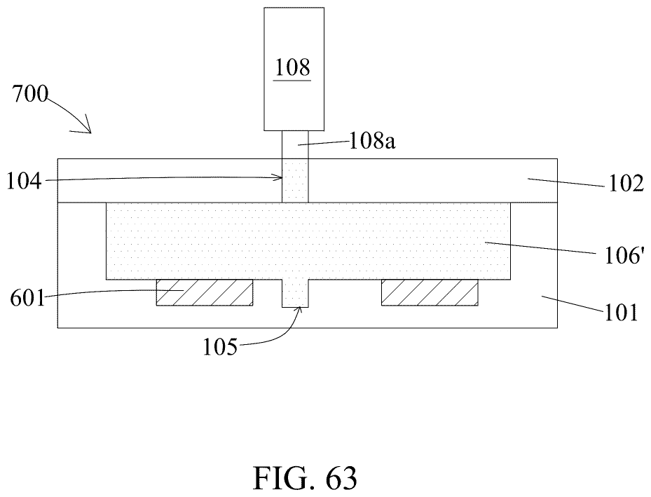

In some embodiments, after the closing of the seventh injection molding device 700 as shown in FIG. 59 and engaging the injector 108 with the seventh injection molding device 700, a flowable material 106′ is flowed from the injector 108 into the mold cavity 103 as shown in FIG. 60. In some embodiments, a flow of the flowable material 106′ is illustrated by FIGS. 61 to 63. In some embodiments, when the flowable material 106′ is injected from the outlet 108a of the injector 108, the flowable material 106′ flows through the feeding port 104 and the mold cavity 103 toward the well 105 as shown by an arrow A in FIG. 61, similar to a way described above or illustrated in FIG. 5. As such, some of the flowable material 106′ is disposed within the well 105. The flowable material 106′ is then continued to flow toward two sidewalls of the mold cavity 103 as shown by an arrow B in FIG. 62, similar to a way described above or illustrated in FIG. 6. In some embodiments, the flowable material 106′ ultimately fills the mold cavity 103 as shown in FIG. 63.

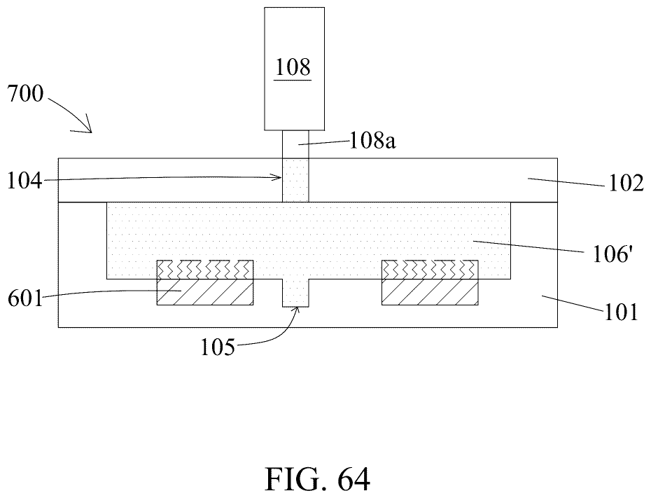

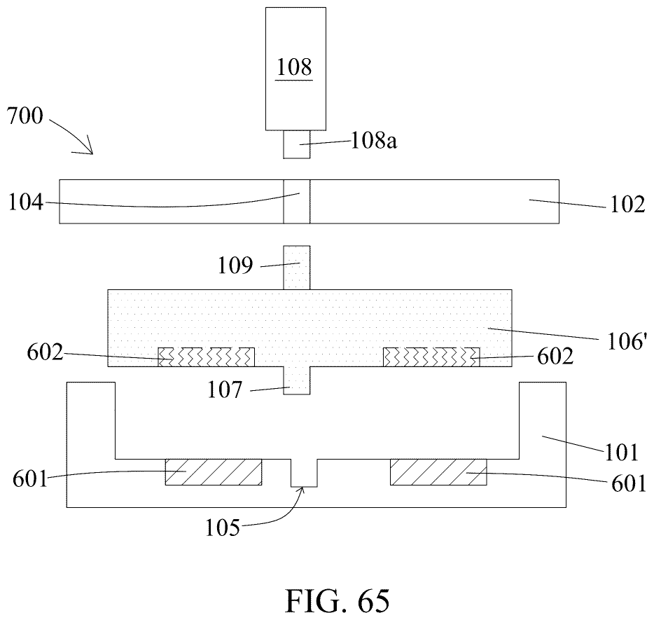

In some embodiments, after the injection of the flowable material 106′ and during the foaming of the flowable material 106′ inside the mold cavity 103, the cooling mechanism 601 is operated as shown in FIG. 64. The cooling mechanism 601 is operated to cool down the flowable material 106′ around the cooling mechanism 601. In some embodiments, the cooling mechanism 601 is operated to cool down the flowable material 106′ from the first predetermined temperature to a second predetermined temperature. In some embodiments, the second predetermined temperature is substantially less than 25° C. In some embodiments, the second predetermined temperature is about 20° C. In some embodiments, a duration for cooling the flowable material 106′ around the cooling mechanism 601 from the first predetermined temperature to the second predetermined temperature by the cooling mechanism 601 is substantially less than 2 seconds.

After the foaming and the cooling of the flowable material 106′, a foamed article 106 with a skin layer 602 is formed as shown in FIG. 60. The skin layer 602 is formed from the flowable material 106′ around the cooling mechanism 601. In some embodiments, the skin layer 602 has a thickness of about 0.5 mm to about 5 mm. In some embodiments, a density gradient is present within the skin layer 602, that a density of the skin layer 602 is gradually increased from an interior of the foamed article 106 to an exterior of the foamed article 106. In some embodiments, the skin layer 602 has lesser degree of physical foaming than the rest portion of the foamed article 106. That is, the rest portion of the foamed article 106 has higher degree of physical foaming than the skin layer 602. In some embodiments, a density of the skin layer 602 is different from a density of the rest portion of the foamed article 106. In some embodiments, the density of the skin layer 602 is substantially greater than the density of the rest portion of the foamed article 106. In some embodiments, the density of the skin layer 602 is substantially equal to or more than 0.2 g/cm³, and the density of the rest portion of the foamed article 106 is substantially less than 0.2 g/cm³. In some embodiments, the density of the skin layer 602 is substantially equal to or more than 0.22 g/cm³, and the density of the rest portion of the foamed article 106 is substantially equal to or less than 0.16 g/cm³. In some embodiments, the skin layer 602 has higher abrasion resistance than the rest portion of the foamed article 106, because the density of the skin layer 602 is higher than the density of the rest portion of the foamed article 106.

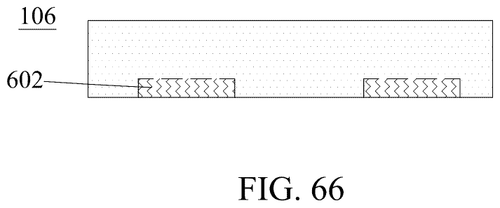

FIG. 65 illustrates an opening of the seventh injection molding device 700 after the formation of the foamed article 106 having the skin layer 602. In some embodiments, the outlet 108a of the injector 108 is disengaged with the feeding port 104 before or after the disengagement of the first mold 101 with the second mold 102. After the opening of the seventh injection molding device 700, the foamed article 106 having the skin layer 602 is taken out from the seventh injection molding device 700 as shown in FIG. 65. In some embodiments, the first protrusion 107 and the second protrusion 109 are removed by cutting, trimming, grinding or any other suitable process, as shown in FIG. 66. In some embodiments, the foamed article 106 is a component of a footwear article, such as an outsole or the like. In some embodiments, the skin layer 602 is exposed to the surroundings, that no adhesive or no other component covers the skin layer 602.

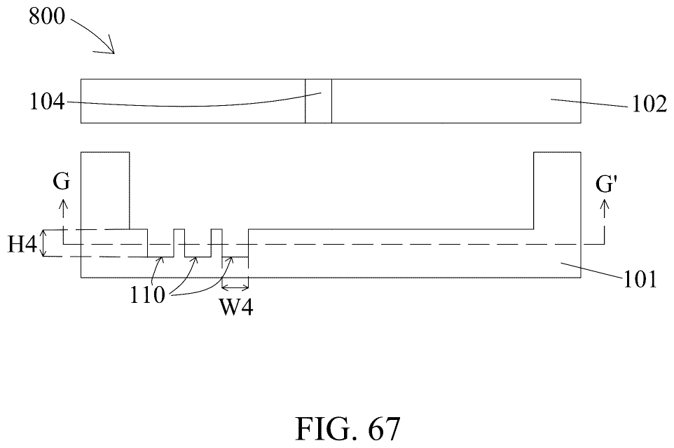

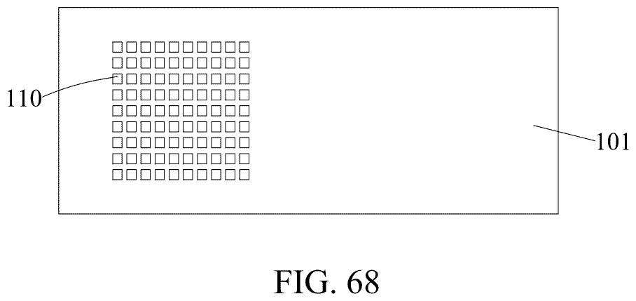

In some embodiments, an eighth injection molding device 800 is used for implementing another injection molding method having several steps as illustrated in FIGS. 67 to 76. FIG. 67 illustrates the eighth injection molding device 800 in an open configuration. In some embodiments, the eighth injection molding device 800 includes the first mold 101, the second mold 102 and the feeding port 104, which are similar to those in the first or second injection molding devices 100 or 200. FIG. 67 shows one feeding port 104 only, but it would be understood that more than one feeding port 104 can be included. In some embodiments, the eighth injection molding device 800 includes several recesses 110 indented into the first mold 101 or the second mold 102. Although FIG. 67 illustrates the recesses 110 are disposed at and recessed into the first mold 101, it would be understood that it is not limited. In some embodiments, the recess 110 is configured to temporarily hold a material. FIG. 68 is a schematic top cross-sectional view of the eighth injection molding device 800 along a line GG′ in FIG. 67. In some embodiments, the recesses 110 are positioned in a predetermined pattern, for example, the recesses 110 are arranged in a matrix. In some embodiments, the recesses 110 are positioned adjacent to one side (e.g. left side, right side, front portion, rear portion, etc.) of the eighth injection molding device 800. In some embodiments, the recesses 110 are laterally offset from a sidewall of the first mold 101 about 0.8 to 1.6 centimeter. In some embodiments, the recess 110 has a height H4 of about 0.3 millimeter and has a width W4 of about 0.3 millimeter.

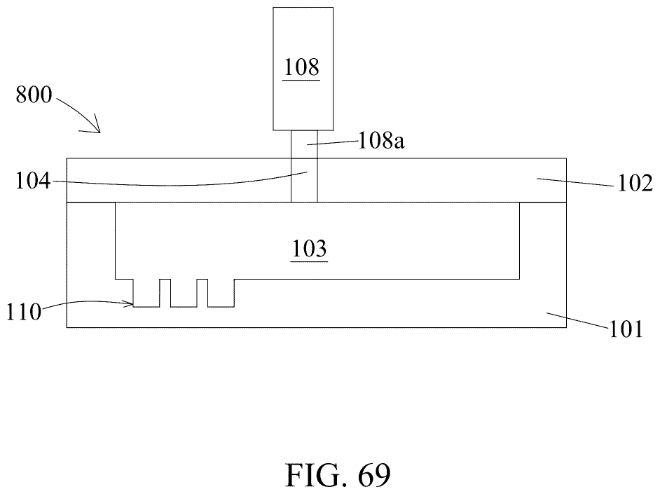

FIG. 69 illustrates the eighth injection molding device 800 in a closed configuration, that the first mold 101 is engaged with the second mold 102. In some embodiments, a mold cavity 103 is formed when the eighth injection molding device 800 is in the closed configuration. In some embodiments, the injector 108 is engaged with the eighth injection molding device 800 before or after the closing of the eighth injection molding device 800. In some embodiments, the outlet 108a of the injector is engaged with the feeding port 104, such that the flowable material can flow from the injector 108 into the mold cavity 103 through the outlet 108a and the feeding port 104.

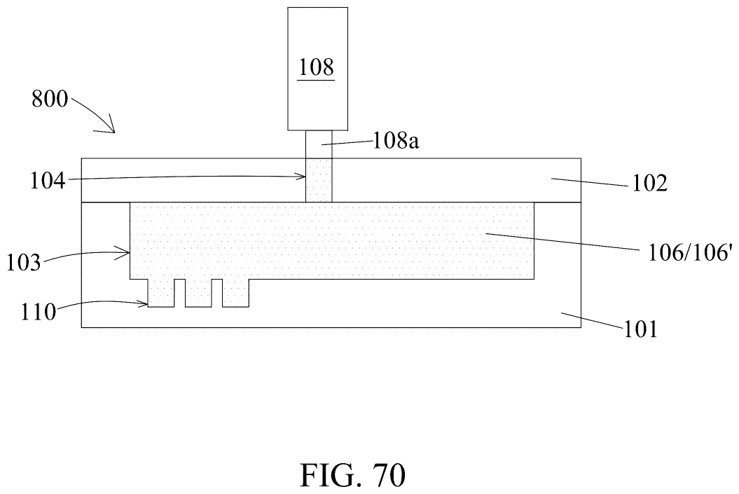

After the engagement of the injector 108, the flowable material 106′ flows into the mold cavity 103 as shown in FIG. 70. In some embodiments, the flowable material 106′ fills the recesses 110. In some embodiments, the flowable material 106′ is a mixture of a polymeric material (such as polyurethane (PU), thermoplastic polyurethane (TPU), etc.) and a blowing agent (such as physical blowing agent, for example carbon dioxide, nitrogen, supercritical fluid, etc.). The mixture is foamable or slightly foamable. The mixture can undergo a physical foaming process within the mold cavity 103. The mixture inside the mold cavity 103 becomes a foamed article after the physical foaming process. In some embodiments, when the flowable material 106′ is injected from the outlet 108a of the injector 108, the flowable material 106′ flows through the feeding port 104 and the mold cavity 103. In some embodiments, during the flowing of the flowable material 106′, the recesses 110 disturb the flowing of the polymer to break air bubble under the skin layer (inside the product), as a result a contact surface (corresponding to the recesses 110) of the product is improved. In comparative example, an additional rubbing or grinding step is used to make the contact surface smooth, but this rubbing or grinding step may not be necessary for the injection molding method of the present disclosure due to the recesses 110.

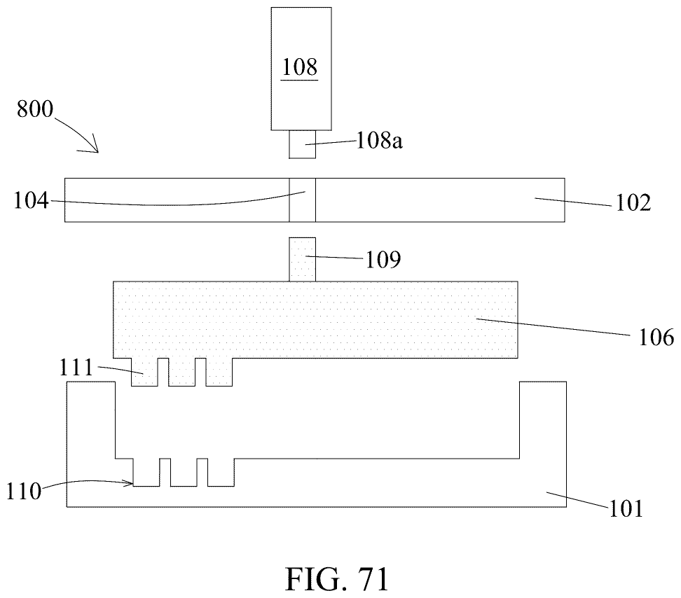

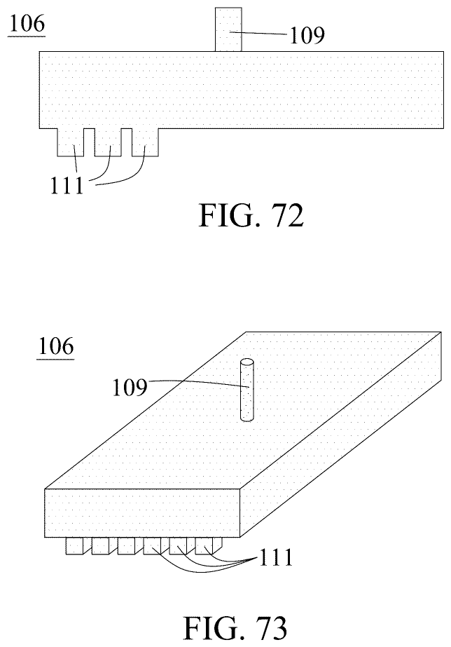

FIG. 71 illustrates an opening of the eighth injection molding device 800 after the formation of the foamed article 106. In some embodiments, the outlet 108a of the injector 108 is disengaged with the feeding port 104 before or after the disengagement of the first mold 101 with the second mold 102. After the opening of the first injection molding device 100, the foamed article 106 is taken out from the eighth injection molding device 800 as shown in FIGS. 71 and 72.

FIGS. 72 and 73 illustrate the foamed article 106 formed by the eighth injection molding device 800. FIG. 72 is a schematic side view of the foamed article 106, and FIG. 73 is a schematic perspective view of the foamed article 106. In some embodiments, the foamed article 106 includes a second protrusion 109 and a third protrusion 111. In some embodiments, the second protrusion 109 corresponds to and is complementary to at least a portion of the feeding port 104, and the third protrusion 111 corresponds to and is complementary to at least a portion of the recess 110.

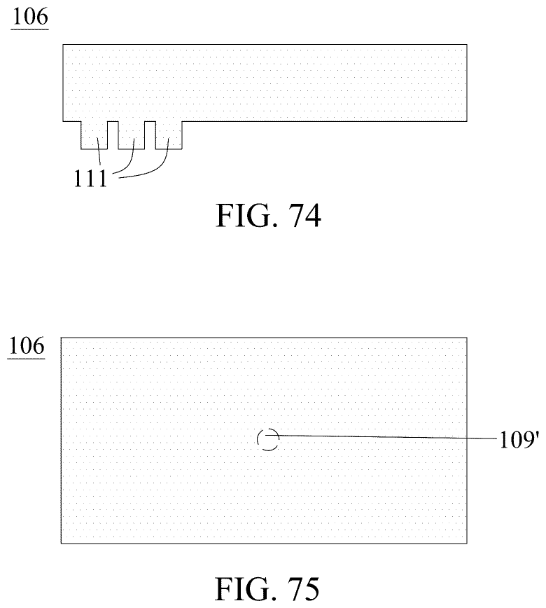

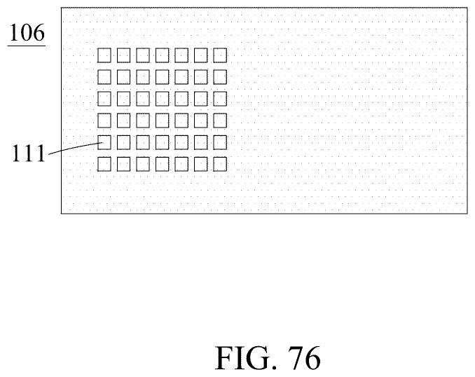

In some embodiments, the second protrusion 109 is removed as shown in FIGS. 74 to 76. FIG. 74 is a schematic side view of the foamed article 106, FIG. 75 is a schematic top view of the foamed article 106, and FIG. 76 is a schematic bottom view of the foamed article 106. In some embodiments, the second protrusion 109 is removed by cutting, trimming, grinding or any other suitable process. As a result, a second trimming trace 109′ is formed on a top surface of the foamed article 106. In some embodiments, the second trimming trace 109′ does not include a skin layer because a skin layer is damaged or removed by the trimming process. In some embodiments, the foamed article 106 is a component of a footwear article, such as an outsole or the like. Since the flowable material 106′ flows into and fills the recesses 110 first and then fills the mold cavity 103, a flow trace on surfaces of the foamed article 106 is absent or minimized. Further, the flowable material 106′ inside the eighth injection molding device 800 has undergone a uniform foaming, and as a result pores inside the foamed article 106 are more evenly distributed and an overall density of the foamed article 106 is also more uniform.

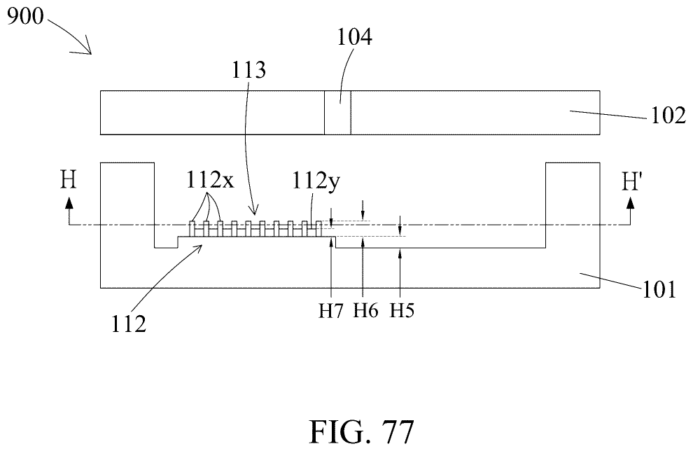

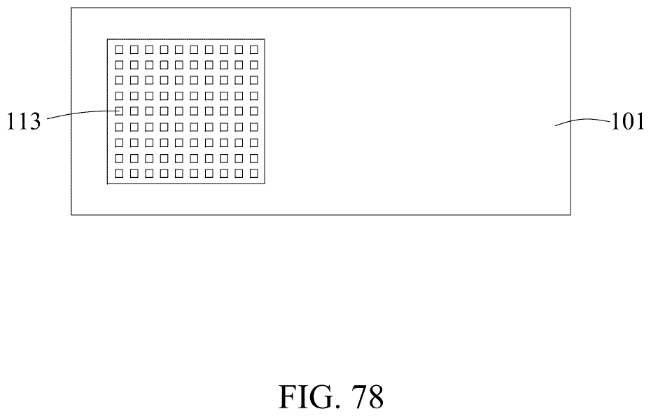

In some embodiments, a ninth injection molding device 900 is used for implementing another injection molding method having several steps as illustrated in FIGS. 77 to 85. FIG. 77 illustrates the ninth injection molding device 900 in an open configuration. In some embodiments, the ninth injection molding device 900 includes the first mold 101, the second mold 102 and the feeding port 104, which are similar to those in the first or second injection molding devices 100 or 200. FIG. 77 shows one feeding port 104 only, but it would be understood that more than one feeding port 104 can be included. In some embodiments, the ninth injection molding device 900 includes a protrusion 112 protruding from the first mold 101 or the second mold 102. Although FIG. 77 illustrates the protrusion 112 is disposed at and protruded the first mold 101, it would be understood that it is not limited. In some embodiments, the protrusion 112 is configured to temporarily disturb the flow of a material with the horizontal protrusions 112x and the vertical protrusions 112y, and temporarily hold the material within the recesses 113. FIG. 78 is a schematic top cross-sectional view of the ninth injection molding device 900 along a line HH' in FIG. 77. In some embodiments, the protrusion 112 is formed in a predetermined pattern, for example, the protrusion 112 is formed as a matrix. In some embodiments, the protrusion 112 is positioned adjacent to one side (e.g. left side, right side, front portion, rear portion, etc.) of the ninth injection molding device 900. In some embodiments, the protrusion 112 is laterally offset from a sidewall of the first mold 101 about 0.8 to 1.6 centimeter. In some embodiments, a base of the protrusion 112 has height H5 about 0.3 millimeter, the horizontal protrusions 112x on the base of the protrusion 112 has a height H6 about 0.3 millimeter, and the vertical protrusions 112y on the base of the protrusion 112 has a height H7 about 0.15 millimeter.

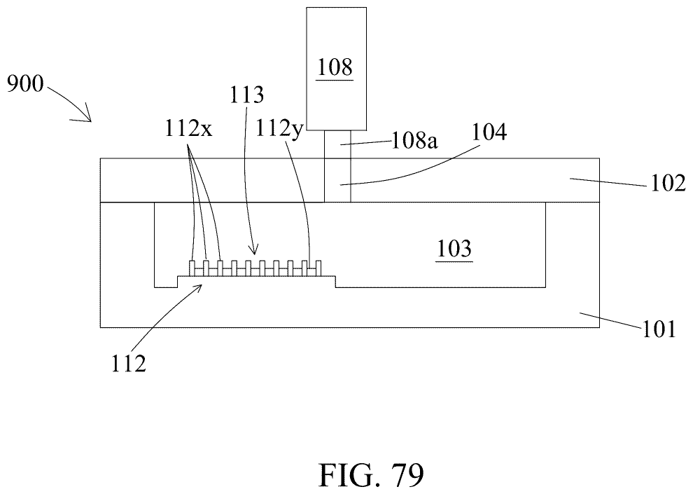

FIG. 79 illustrates the ninth injection molding device 900 in a closed configuration, that the first mold 101 is engaged with the second mold 102. In some embodiments, a mold cavity 103 is formed when the ninth injection molding device 900 is in the closed configuration. In some embodiments, the injector 108 is engaged with the ninth injection molding device 900 before or after the closing of the ninth injection molding device 900. In some embodiments, the outlet 108a of the injector is engaged with the feeding port 104, such that the flowable material can flow from the injector 108 into the mold cavity 103 through the outlet 108a and the feeding port 104.

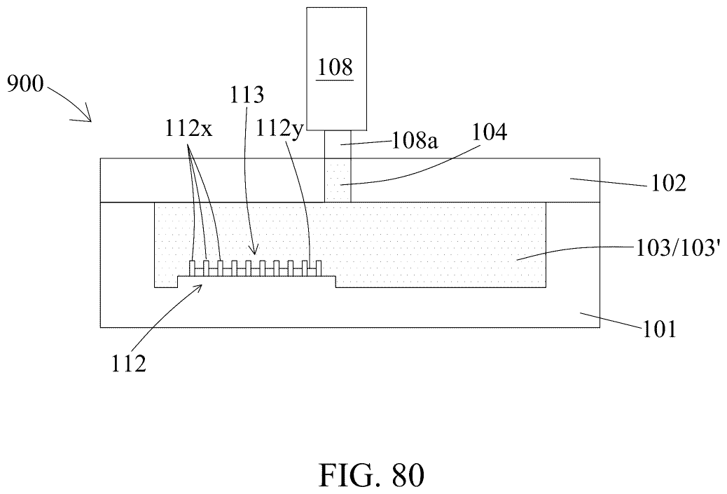

After the engagement of the injector 108, the flowable material 106′ flows into the mold cavity 103 as shown in FIG. 80. In some embodiments, the flowable material 106′ fills the recesses 113. In some embodiments, the flowable material 106′ is a mixture of a polymeric material (such as polyurethane (PU), thermoplastic polyurethane (TPU), etc.) and a blowing agent (such as physical blowing agent, for example carbon dioxide, nitrogen, supercritical fluid, etc.). The mixture is foamable or slightly foamable. The mixture can undergo a physical foaming process within the mold cavity 103. The mixture inside the mold cavity 103 becomes a foamed article after the physical foaming process. In some embodiments, when the flowable material 106′ is injected from the outlet 108a of the injector 108, the flowable material 106′ flows through the feeding port 104 and the mold cavity 103. In some embodiments, during the flowing of the flowable material 106′, the protrusion 112 and the recesses 113 disturb the flowing of the polymer to break air bubble under the skin layer (inside the product), as a result a contact surface (corresponding to the protrusion 112 and the recesses 113) of the product is improved. In comparative example, an additional rubbing or grinding step is used to make the contact surface smooth, but this rubbing or grinding step may not be necessary for the injection molding method of the present disclosure due to the protrusion 112 and the recesses 113.

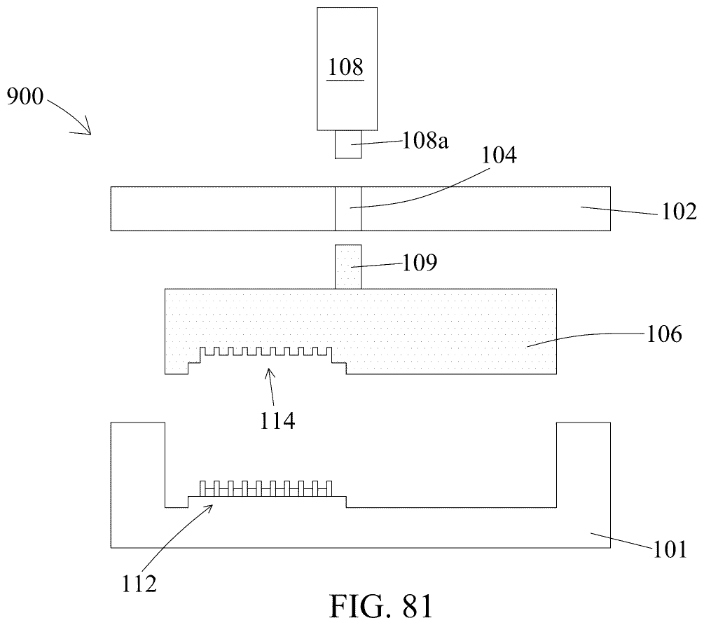

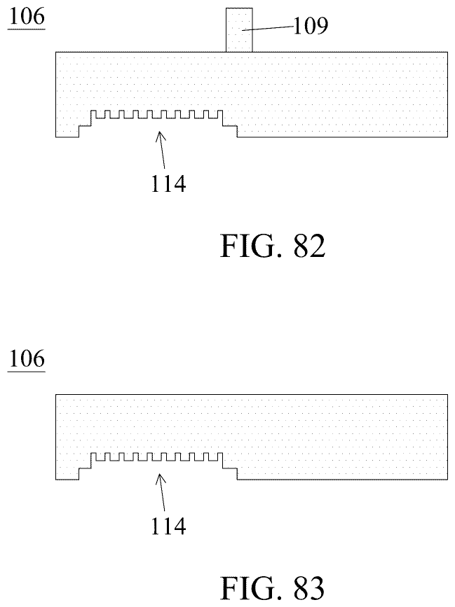

FIG. 81 illustrates an opening of the ninth injection molding device 900 after the formation of the foamed article 106. In some embodiments, the outlet 108a of the injector 108 is disengaged with the feeding port 104 before or after the disengagement of the first mold 101 with the second mold 102. After the opening of the first injection molding device 100, the foamed article 106 is taken out from the ninth injection molding device 900 as shown in FIGS. 81 and 82.

FIGS. 82 and 83 illustrate the foamed article 106 formed by the ninth injection molding device 900. FIG. 82 is a schematic side view of the foamed article 106, and FIG. 83 is a schematic perspective view of the foamed article 106. In some embodiments, the foamed article 106 includes a second protrusion 109 and a recess 114. In some embodiments, the second protrusion 109 corresponds to and is complementary to at least a portion of the feeding port 104, and the recess 114 corresponds to and is complementary to at least a portion of the protrusion 112.

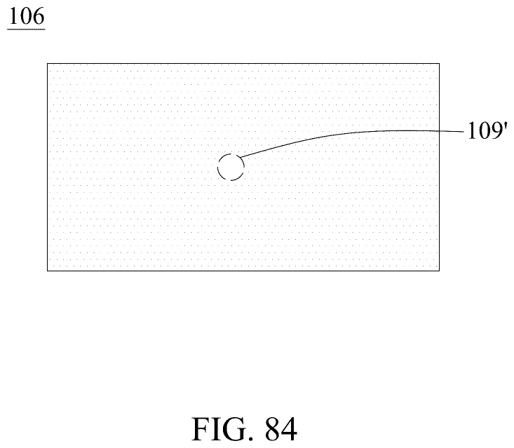

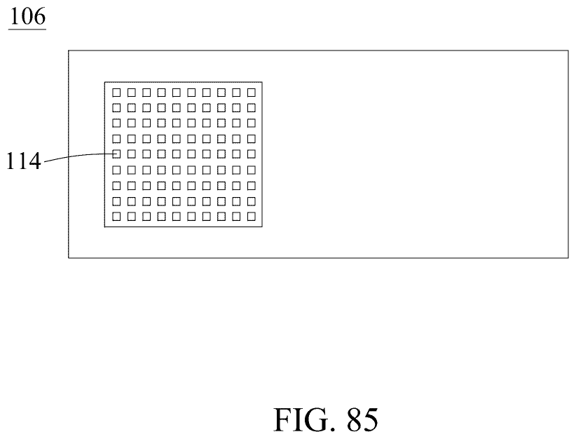

In some embodiments, the second protrusion 109 is removed as shown in FIGS. 84 to 85. FIG. 84 is a schematic top view of the foamed article 106, and FIG. 85 is a schematic bottom view of the foamed article 106. In some embodiments, the second protrusion 109 is removed by cutting, trimming, grinding or any other suitable process. As a result, a second trimming trace 109′ is formed on a top surface of the foamed article 106. In some embodiments, the second trimming trace 109′ does not include a skin layer because a skin layer is damaged or removed by the trimming process. In some embodiments, the foamed article 106 is a component of a footwear article, such as an outsole or the like. Since the flowable material 106′ flows into and fills the recesses 113 to form the recesses 114 first, and then fills the mold cavity 103, a flow trace on surfaces of the foamed article 106 is absent or minimized. Further, the flowable material 106′ inside the ninth injection molding device 900 has undergone a uniform foaming, and as a result pores inside the foamed article 106 are more evenly distributed and an overall density of the foamed article 106 is also more uniform.

What is claimed is:

1. A molding method, comprising:
providing a molding device including a first mold and a second mold, wherein the first mold includes a recess recessed into the first mold, and the second mold includes a feeding port extending through the second mold;
engaging the first mold with the second mold to form a mold cavity defined by the first mold and the second mold, wherein the mold cavity is communicable with the recess and the feeding port;
injecting a flowable material into the mold cavity through the feeding port to fill the recess and the mold cavity; and
foaming the flowable material to a foamed article.

2. The method of claim 1, wherein the feeding port is aligned with the recess.

3. The method of claim 2, wherein the flowable material fills an entirety of the recess, and then at least partially fills the mold cavity.

4. The method of claim 1, wherein the feeding port is misaligned with the recess.

5. The method of claim 1, wherein the foamed article includes a first protrusion within the recess.

6. The method of claim 5, further comprising:
taking the foamed article out of the molding device;
removing the first protrusion from the foamed article,
wherein a first trimming trace is formed on the foamed article corresponding to the first protrusion after the removal.

7. The method of claim 6, wherein the foamed article includes a second protrusion within the feeding port.

8. The method of claim 7, further comprising:
removing the second protrusion from the foamed article,
wherein a second trimming trace is formed on the foamed article corresponding to the second protrusion after the removal.

9. The method of claim 7, wherein the first protrusion is aligned with the second protrusion.

10. A molding method, comprising:
providing a molding device including a first mold and a second mold, wherein the first mold or the second mold includes a cooling mechanism embedded in the first mold, and the second mold includes a feeding port extending through the second mold;
engaging the first mold with the second mold to form a mold cavity defined by the first mold and the second mold;
injecting a flowable material into the mold cavity through the feeding port;
operating the cooling mechanism to cool down the flowable material around the cooling mechanism; and
foaming the flowable material to a foamed article.

11. The method of claim 10, wherein the foamed article has a skin layer adjacent to the cooling mechanism, and the skin layer has a density gradient gradually increased from an interior of the foamed article to an exterior of the foamed article.

12. The method of claim 10, wherein a density of the skin layer is substantially greater than a density of a rest portion of the foamed article.

13. The method of claim 10, wherein the density of the skin layer is substantially equal to or greater than 0.2 g/cm³.

14. The method of claim 10, wherein the method further comprising:
adjusting the molding device to a first predetermined temperature before the injection of the flowable material;
maintaining the molding device at the first predetermined temperature during the injection of the flowable material,
wherein the operation of the cooling mechanism includes cooling the flowable material around the cooling mechanism from the first predetermined temperature to a second predetermined temperature substantially lower than the first predetermined temperature.

15. The method of claim 14, wherein a difference between the first predetermined temperature and the second predetermined temperature is substantially greater than 10° C.

16. The method of claim 11, wherein the first mold includes a recess recessed into the first mold and coupled with the mold cavity, the flowable material is flowed into the recess during the injecting the flowable material into the mold cavity, and the foamed article includes a first protrusion within the recess.

17. The method of claim 16, wherein a density of the skin layer is substantially greater than a density of the first protrusion.

18. A foamed article, comprising:
a first surface, a second surface opposite to the first surface, and a third surface between the first surface and the second surface;
a first trace disposed on the first surface, and
a second trace disposed on the second surface, opposite to the first trace and vertically aligned with the first trace.

19. The foamed article of claim 18, furthering comprising:
a third trace disposed on the first surface, the second surface or the third surface, wherein a surface area of the third trace is substantially smaller than a surface area of the second trace.

20. The foamed article of claim 18, furthering comprising:
a skin layer exposed through the first surface, the second surface or the third surface,
wherein an abrasion resistance of the skin layer is greater than a rest portion of the foamed article, and the skin layer has a density gradient gradually increased from an interior of the foamed article to an exterior of the foamed article.
